(19) United States
(12) Patent Application Publication
(10) Pub. No.: US 2026/0238654 A1
(43) Pub. Date: Aug. 13, 2026

(54) Auto Evaluation of Generated Content Context with SMPE and Event-Based Corroboration Tokens in a Decentralized Network

(71) Applicant: Bank of America Corporation, Charlotte, NC (US)

(72) Inventors: Pratap Dande, Saint Johns, FL (US); Anchal Agarwal, Frisco, TX (US); Sheldon M. Berke, Steamboat, CO (US); Sudhir Ancha, Jacksonville, FL (US); Naga Vamsi Krishna Akkapeddi, Charlotte, NC (US); Patricia A. Medeiros, Barrington, RI (US); Vinit Shah, Indian Trail, NC (US); Rama Avvaru, St. Johns, FL (US)

(21) Appl. No.: 19/047,921

(22) Filed: Feb. 7, 2025

(51) Int. Cl. H04L 9/40; H04L 9/32

(52) U.S. Cl. CPC H04L 63/12; H04L 9/3213

(57) ABSTRACT

This invention provides a system and method for managing and validating transaction data in decentralized networks, ensuring accuracy, contextual relevance, and security. The system detects missing data using a pre-trained custom model and predicts missing elements via a k-Nearest Neighbors (KNN) algorithm. It establishes contextual relationships using advanced semantic analysis, generating multiple transaction versions filtered for relevance and validity. Each validated version is transformed into cryptographic digital tokens encapsulating both content and context. A Secure Multi-Party Engine (SMPE) refines validation by generating application-specific sub-tokens, which are authenticated by decentralized applications. Responses are consolidated into a unified authentication token to ensure integrity. The event-driven architecture facilitates low-latency token distribution and validation across the network, while the hierarchical sub-token structure enhances security and granularity. This comprehensive framework addresses challenges of incomplete data, decentralized validation, and scalable processing, providing a robust, adaptable solution for distributed environments such as finance and supply chains.

### TECHNICAL FIELD

The inventions disclosed herein pertain to the field of artificial intelligence, specifically to data processing systems employing machine learning and neural networks to address issues such as incomplete data handling, contextual analysis, and decentralized validation. The system integrates advanced predictive algorithms, including k-Nearest Neighbors (KNN), and semantic analysis models for generating, contextualizing, and validating transaction data in distributed networks. By utilizing pre-trained models and transformer-based contextualization, the invention ensures accurate and contextually aligned transaction data management, enabling adaptive and intelligent processing in decentralized environments.

### DESCRIPTION OF THE RELATED ART

The problem centers around ensuring data integrity, accuracy, and contextual relevance in decentralized networks, particularly when Generative AI is used for predicting missing or corrective content. Decentralized systems often experience issues such as data loss or corruption as information flows through multiple nodes or applications, each potentially operating on different platforms with varying protocols. These discrepancies can lead to incomplete or inaccurate transaction data, creating challenges in maintaining the authenticity of the original data sent by the source system. Generative AI introduces another layer of complexity as it attempts to predict and replace the missing content. While AI can reconstruct missing pieces, it can inadvertently introduce extraneous or irrelevant data that was never part of the original transaction, or misplace the reconstructed data, thereby altering the intended sequence and context.

Consider an example in which a source system transmits a transaction containing elements A, B, C, E, I, F, and H, but during transmission, critical components such as C and F are lost. Generative AI may attempt to recreate the missing components, correctly generating C and F, but also generating unrelated elements such as D and G, which were never part of the original transaction. Moreover, the placement of F, which should follow I, may be incorrectly positioned due to a lack of contextual understanding. This leads to a transaction dataset that not only contains errors but also jeopardizes its authenticity and legality.

Another layer of the issue arises from the contextual relationships between data points. In many transactional systems, the sequence and interdependencies of data elements are crucial for ensuring that the transaction reflects its intended purpose. If Generative AI predicts missing data but fails to accurately position it within the contextual framework of the transaction, the integrity of the data is compromised. For example, financial transactions rely heavily on the correct ordering of data elements to maintain their coherence and legality. A misstep in the contextual arrangement can render the transaction invalid or misleading.

Decentralized networks add to the challenge by necessitating a collaborative yet secure approach to validating and authenticating data across multiple stakeholders. Centralized systems are often insufficient for these tasks due to their lack of scalability, adaptability, and transparency. Decentralized systems require a distributed mechanism capable of verifying data integrity while preserving the privacy and security of the network's participants. Without such mechanisms, the network risks perpetuating errors or allowing fraudulent data to infiltrate the system, eroding trust and causing potential systemic issues.

Manual intervention to validate and verify predicted content is time-consuming and prone to human error, particularly as the scale and complexity of decentralized networks grow. Automating the validation process becomes essential to ensure that transactions are evaluated against predefined metrics such as relevance, authenticity, and coherence. However, automation introduces its challenges, as the system must also identify and discard irrelevant or extraneous data that could compromise the integrity of the transaction.

The problem becomes more pronounced when considering the multiplicity of applications and stakeholders within the decentralized network. Each application may require data tailored to its unique operational requirements, further complicating the process of data validation and contextual alignment. For instance, one application might only need a subset of the data to validate its portion of the transaction, while another might need a more comprehensive view. Ensuring that each application receives the correct and relevant data without exposing unrelated or sensitive information requires a highly secure and adaptable framework.

Cryptographic solutions provide a foundation for ensuring data authenticity and integrity but often lack the ability to tie these validations to real-world contexts or temporal relationships. For example, while cryptographic tokens can authenticate data, they do not inherently ensure that the data fits within the intended sequence or context of the transaction. This limitation further underscores the need for an integrated solution that combines cryptographic validation with contextual and temporal alignment.

Additionally, as Generative AI reconstructs missing data, it may produce multiple versions of the predicted content, each representing a different interpretation of the missing elements. Determining which version is the most accurate and contextually relevant requires a sophisticated filtering mechanism capable of evaluating each version against the transaction's predefined metrics. Without such a mechanism, the system risks processing incorrect or incomplete transactions, leading to potential errors and inefficiencies.

The proliferation of decentralized networks necessitates a scalable solution that can evaluate and validate transactions across multiple participants while preserving privacy and security. Existing solutions often fail to address the scalability and adaptability required to operate in such environments. This gap highlights the need for a robust framework that can seamlessly integrate with various systems and processes while maintaining the integrity of the data.

The long-felt and unmet need lies in developing a comprehensive solution that addresses these challenges by integrating predictive capabilities with contextual understanding in a decentralized, secure framework. The absence of such a solution has hindered the ability of decentralized networks to fully realize their potential in handling complex, multi-stakeholder transactions. By addressing the dual challenges of scalability and contextual integrity, the proposed approach would provide a transformative advancement, enabling decentralized networks to achieve a higher level of reliability and trustworthiness in processing transactions. This would meet the growing demand for systems that can handle complex, dynamic data environments without sacrificing security, privacy, or accuracy.

### SUMMARY OF THE INVENTION

The invention provides a comprehensive system and method for managing and validating transaction data in decentralized networks, offering a robust solution to ensure accuracy, contextual relevance, and security throughout the transaction lifecycle. This system integrates advanced machine learning algorithms, cryptographic techniques, and decentralized validation mechanisms to address the complexities of distributed environments. It is designed to maintain the integrity of transaction data as it traverses multiple nodes and applications in decentralized networks, where data consistency and contextual alignment are paramount. The invention is particularly suited to applications in industries requiring high levels of data reliability, such as finance, supply chain management, and other domains with critical transaction workflows.

A cornerstone of the invention is its missing data detection module, which employs a pre-trained custom model to evaluate incoming transaction data. The model is designed to analyze the structure and content of each transaction to identify missing elements or inconsistencies. By referencing historical transaction datasets specific to the domain of application, the model can accurately detect gaps that might otherwise compromise the completeness and validity of the transaction. This early-stage detection prevents incomplete data from propagating further in the system, thereby maintaining the integrity of subsequent processing stages. The model's domain-specific training ensures that it aligns with the unique requirements of various industries, enhancing its adaptability and precision.

Once missing data is identified, the system transitions to a predictive modeling module that infers the missing elements using the k-Nearest Neighbors (KNN) algorithm. This algorithm is particularly effective in handling incomplete datasets by analyzing patterns and similarities among existing data points. The KNN algorithm uses a weighted similarity metric to prioritize recent and contextually relevant data, ensuring that the predicted elements align with the most current trends and practices. This predictive modeling capability not only restores missing data but does so with a high degree of accuracy and contextual coherence, making it a reliable tool for reconstructing transaction information.

The invention's contextualization module builds upon the predictions by integrating them with the existing transaction data. This module evaluates the logical relationships, dependencies, and sequence of data elements to construct a comprehensive contextual framework for the transaction. Advanced semantic analysis techniques, including transformer-based models, are employed to ensure that the predicted data aligns seamlessly with the original intent of the transaction. This deep contextual understanding allows the system to generate multiple enriched versions of the transaction, each representing a plausible configuration of the data. These versions serve as a foundation for ensuring that the transaction remains consistent with its intended purpose, even as it passes through decentralized environments.

To ensure the quality and reliability of the generated transaction versions, the invention incorporates a version filtering module. This module uses ensemble modeling techniques to evaluate the validity and relevance of each version against predefined metrics. By combining outputs from multiple pre-trained models, the system enhances the accuracy of its filtering process. Dynamic adjustment of filtering thresholds based on historical success rates further ensures that only the most contextually appropriate and accurate versions are retained. This step significantly reduces the risk of invalid or irrelevant data being processed downstream, thereby improving the overall reliability of the system.

The validated transaction versions are then transformed into digital tokens through a specialized tokenization module. Each token encapsulates both the content and context of its respective transaction version, providing a secure and immutable representation of the data. Cryptographic techniques, such as homomorphic encryption, are employed during the tokenization process to protect sensitive information while maintaining the system's ability to perform operations on the encrypted data. These tokens serve as the cornerstone for data traceability and validation within decentralized networks, ensuring that the integrity and authenticity of the transaction are preserved throughout its lifecycle.

The invention utilizes an event-driven architecture to publish these digital tokens as events to the decentralized network. This architecture facilitates the low-latency distribution of tokens, allowing network participants to access and validate them in real-time. By integrating with distributed ledger technologies, the event management module creates a tamper-proof record of token events. This transparent and immutable log enhances accountability within the network and provides stakeholders with confidence in the system's operations. The decentralized nature of the token-based event mechanism reduces reliance on centralized authorities and aligns with the principles of distributed systems.

A significant innovation within the invention is the Secure Multi-Party Engine (SMPE), which enhances the granularity and efficiency of the validation process. The SMPE generates sub-tokens from the digital tokens, tailoring each sub-token to the specific requirements of individual applications in the network. These sub-tokens contain only the data relevant to their respective applications, minimizing unnecessary exposure and ensuring that each application receives precisely the information it needs. This hierarchical sub-token structure reflects the dependencies among data elements, further enhancing the security and efficiency of the data validation process.

Applications within the decentralized network consume their respective sub-tokens and perform an initial validation process, known as a soft commit. These applications then send their validation responses back to the SMPE, which aggregates them into a unified authentication token. This token represents the collective validation of the transaction data by multiple independent applications, providing a decentralized and robust mechanism for ensuring data integrity. The threshold-based consensus mechanism employed by the SMPE ensures that the validation process is secure and resistant to manipulation, even in environments with potentially untrusted participants.

The invention's final filtering process evaluates the validated transaction versions against the contents of the authentication token. This step ensures that only the version of the transaction data matching the authenticated token proceeds to downstream applications. Any versions that do not align with the token are discarded, guaranteeing that the transaction data remains accurate and contextually coherent. This rigorous validation framework is critical for maintaining the reliability and trustworthiness of the system, particularly in high-stakes environments where data integrity is paramount.

Once the transaction is fully validated, it is prepared for downstream processing through a transaction processing module. This module formats the validated data to ensure compatibility with subsequent applications or systems. It also generates a comprehensive audit trail documenting every step of the transaction lifecycle, from initial detection to final validation. This transparent and traceable record facilitates compliance with regulatory requirements and provides stakeholders with assurance regarding the system's reliability and accuracy.

The modular architecture of the invention allows each component to operate independently while remaining interconnected within the overall framework. This design enables the system to scale horizontally, accommodating increasing transaction volumes without compromising performance. The event-driven architecture supports distributed and parallel processing, making the system highly efficient even in high-throughput environments. This scalability ensures that the invention can adapt to the growing demands of decentralized networks.

The adaptability of the invention extends to its ability to integrate with various domains and industries. The pre-trained models used in the system can be customized for specific applications, such as financial services, logistics, or supply chain management. This domain-specific training allows the system to address unique challenges and requirements effectively. Additionally, the system's integration capabilities enable seamless connectivity with existing enterprise systems and external data sources, further enhancing its versatility and utility.

Security and privacy are central to the invention's design. By employing cryptographic techniques, such as homomorphic encryption, the system ensures that sensitive transaction data remains protected throughout its lifecycle. The hierarchical structure of sub-tokens adds an additional layer of security by limiting data exposure to only what is necessary for each application. This focus on security makes the invention a trusted solution for managing sensitive data in decentralized environments.

The invention's innovative approach, combining machine learning, cryptographic security, and decentralized validation, sets a new standard for transaction data management. It addresses the challenges of incomplete data, contextual alignment, and decentralized validation with unparalleled precision and efficiency. Its robust and adaptable framework provides a reliable solution for managing complex workflows in distributed systems. The invention represents a transformative advancement in the field, offering enhanced reliability, security, and scalability for transaction data management in decentralized networks.

Notably, the invention features several unique aspects that collectively make it a highly innovative and efficient solution for managing transaction data in decentralized networks. These unique features are described in detail below, emphasizing their contributions to the invention's overall functionality and benefits.

The hybrid interpretation of transaction data by predicting missing data using machine learning and building context using a custom Python model is a core innovation of the system. The integration of the k-Nearest Neighbors (KNN) algorithm allows the system to analyze patterns in existing data to predict missing elements accurately. This predictive capability is enhanced by the Python-based custom model, which contextualizes the predicted data by evaluating logical relationships and dependencies within the transaction. This dual-layered approach ensures that the restored transaction data is not only complete but also contextually coherent, reducing the risk of errors in subsequent processing stages.

Evaluating transaction data versions with a custom model based on modeling is another key aspect of the invention. Once multiple versions of the transaction are generated during the contextualization phase, the system employs a custom model to assess their validity and relevance. This model uses pre-trained filters and ensemble modeling techniques to identify and retain only the most accurate and contextually appropriate versions. By leveraging advanced modeling, the system ensures that only the highest-quality data versions proceed to the next stage, significantly enhancing the reliability and accuracy of the transaction lifecycle.

The use of token-based events in a decentralized network to authenticate predicted and contextually arranged data versions is a groundbreaking feature. After filtering the transaction versions, the system transforms each valid version into a unique digital token. These tokens are published as events to the decentralized network, allowing participating applications to access and validate them in real-time. This event-driven architecture facilitates distributed validation and ensures that data can be authenticated independently by multiple nodes, aligning with the principles of decentralization and reducing reliance on centralized authorities.

The secure multi-party engine (SMPE) plays a pivotal role in preparing sub-tokens that are specific to individual applications. Each application in the decentralized network may require only a subset of the transaction data for its specific functions. The SMPE generates sub-tokens by segmenting the original digital tokens into application-specific components, ensuring that each application receives exactly the data it needs. This granular approach not only enhances data security by minimizing unnecessary exposure but also improves processing efficiency by providing applications with tailored data sets.

The invention further utilizes the secure multi-party engine to combine all sub-tokens and prepare an authentication token that represents the data version authenticated by participating applications. Once the sub-tokens are validated by the respective applications, the SMPE consolidates their responses into a unified authentication token. This consolidated token reflects the collective validation of all applications involved, providing a robust mechanism for ensuring data integrity and trustworthiness in the decentralized network. This feature is particularly valuable in scenarios where multiple applications must collaborate to validate complex transactions.

Re-evaluating the transaction data versions based on the authentication token event is another critical feature of the invention. The system uses the authentication token as a definitive reference to verify the accuracy and contextual relevance of the validated transaction version. Any data versions that do not align with the authentication token are discarded at this stage. This re-evaluation process adds an additional layer of assurance, ensuring that only the most accurate and authenticated data version is prepared for downstream processing.

The process of finalizing the right version of data with the authentication token represents the culmination of the system's multi-step validation and filtering framework. After re-evaluation, the validated transaction version is formatted for compatibility with subsequent applications and prepared for further use. This finalization step ensures that the transaction data is complete, accurate, and contextually aligned with the original intent of the source application. Additionally, the system creates an audit trail documenting every step of the process, providing a transparent record for compliance and accountability.

Each of these unique aspects contributes to the invention's ability to manage transaction data effectively in decentralized networks. By integrating machine learning, contextual modeling, cryptographic tokenization, and decentralized validation, the system addresses critical challenges such as data integrity, security, and scalability. These features collectively make the invention a transformative solution for managing and validating transaction data in distributed environments.

In light of the foregoing, the following provides a simplified summary of the present disclosure to offer a basic understanding of its various parts. This summary is not exhaustive, nor does it limit the exemplary aspects of the inventions described herein. It is not designed to identify key or critical elements or steps of the disclosure, nor to define its scope. Rather, it is intended, as understood by a person of ordinary skill in the art, to introduce some concepts of the disclosure in a simplified form as a precursor to the more detailed description that follows. The specification throughout this application contains sufficient written descriptions of the inventions, including exemplary, non-exhaustive, and non-limiting methods and processes for making and using the inventions. These descriptions are presented in full, clear, concise, and exact terms to enable skilled artisans to make and use the inventions without undue experimentation, and they delineate the best mode contemplated for carrying out the inventions.

In some arrangements, a method for managing and validating transaction data in a decentralized network includes detecting, by a missing data detection module, one or more missing data elements in an input transaction received from a source application, wherein the missing data detection module utilizes a pre-trained model trained on historical transaction datasets to identify gaps based on transaction type and associated features. The method further includes predicting, by a predictive modeling module, the one or more missing data elements identified by the missing data detection module, wherein the predictive modeling module applies a k-nearest neighbors algorithm with a weighted similarity metric to infer the missing data elements based on patterns observed in historical transaction data. The method also involves constructing, by a contextualization module, a contextual framework for the input transaction by integrating the predicted missing data elements with the input transaction, wherein the contextualization module evaluates logical relationships, sequence dependencies, and semantic relevance of the data elements to generate multiple transaction versions.

Additionally, the method includes filtering, by a version filtering module, the multiple transaction versions to retain a set of valid transaction versions, wherein the version filtering module employs ensemble modeling techniques to enhance accuracy. The method further includes tokenizing, by a tokenization module, each valid transaction version to generate a plurality of digital tokens, wherein each digital token encapsulates the content and context of its corresponding transaction version, and wherein the tokenization module applies homomorphic encryption to secure the digital tokens. Finally, the method includes publishing, by an event management module, the digital tokens as events to a decentralized network, generating application-specific sub-tokens by a secure multi-party engine, validating sub-tokens through application nodes, consolidating validation responses into an authentication token, and preparing the validated transaction for downstream processing.

In some arrangements, the pre-trained model utilized by the missing data detection module is dynamically updated based on feedback from validated transaction versions. This dynamic update allows the pre-trained model to refine its capabilities over time, improving the accuracy of detecting missing data elements and ensuring alignment with evolving transaction patterns in the decentralized network.

In some arrangements, the predictive modeling module incorporates temporal features into the k-nearest neighbors algorithm. These temporal features allow the predictive modeling module to account for time-sensitive patterns and trends in transaction data, ensuring that the inferred missing elements are both contextually and temporally aligned with the input transaction's requirements.

In some arrangements, the contextualization module integrates external data inputs from public APIs or domain-specific knowledge graphs to enrich the contextual framework for the predicted missing data elements. These external inputs provide additional insights and allow the system to dynamically adapt the contextualization process to include broader data sources, enhancing the accuracy and relevance of the generated transaction versions.

In some arrangements, the version filtering module adjusts its ensemble modeling techniques dynamically based on historical success rates of the pre-trained models. This adjustment prioritizes models that demonstrate higher accuracy for similar transaction types, ensuring that only the most contextually valid and accurate transaction versions are retained for downstream processing.

In some arrangements, the tokenization module associates metadata with each digital token it generates, including timestamps, transaction type, and contextual validation scores. This metadata enhances traceability, allowing for more detailed analysis and improved accountability of each transaction version within the decentralized network

In some arrangements, the event management module integrates with distributed ledger technologies to immutably log the digital tokens on a blockchain. This integration ensures that all digital tokens are securely stored, providing enhanced auditability, security, and transparency for transactions in the decentralized network.

In some arrangements, the secure multi-party engine employs machine learning-based optimization algorithms to minimize computational overhead associated with generating and processing sub-tokens. These optimization algorithms improve the efficiency of the secure multi-party engine, enabling it to handle high transaction volumes while maintaining the security and granularity of sub-token generation.

In some arrangements, the transaction processing module supports multi-format data outputs, including JSON, XML, and custom schemas. By supporting these data formats, the transaction processing module ensures seamless integration of the validated transaction version with a wide variety of downstream applications and enterprise systems, enhancing adaptability and interoperability.

In some arrangements, the transaction processing module generates a comprehensive audit trail that documents each step of the transaction lifecycle, including missing data detection, prediction, contextualization, token generation, validation, and final preparation for downstream applications. This detailed audit trail ensures compliance with regulatory standards and provides enhanced accountability and traceability for all processed transactions.

In some arrangements, a method for managing, validating, and processing transaction data in a decentralized network includes detecting, by a missing data detection module, one or more missing data elements in an input transaction received from a source application, wherein the missing data detection module utilizes a pre-trained model trained on historical transaction datasets specific to a predetermined domain to identify gaps based on transaction type and associated features, and wherein the pre-trained model is dynamically updated based on feedback from validated transaction versions. The method further includes predicting, by a predictive modeling module, the one or more missing data elements identified by the missing data detection module, wherein the predictive modeling module applies a k-nearest neighbors algorithm with a weighted similarity metric to infer the missing data elements based on patterns observed in historical transaction data, and wherein the predictive modeling module incorporates temporal features into the k-nearest neighbors algorithm to account for time-sensitive patterns and trends. The method also involves constructing, by a contextualization module, a contextual framework for the input transaction by integrating the predicted missing data elements with the input transaction, wherein the contextualization module evaluates logical relationships, sequence dependencies, and semantic relevance of the data elements, employs transformer-based semantic analysis to enhance contextual alignment, and integrates external data inputs from public APIs or domain-specific knowledge graphs to improve the contextualization process.

The method includes filtering, by a version filtering module, the multiple transaction versions generated by the contextualization module to retain a set of valid transaction versions, wherein the version filtering module employs ensemble modeling techniques to combine outputs from multiple pre-trained models, dynamically adjusts filtering thresholds based on historical success rates, and prioritizes models demonstrating higher accuracy for similar transaction types. Each valid transaction version is transformed, by a tokenization module, into a plurality of digital tokens, wherein each digital token encapsulates the content and context of its corresponding transaction version, and wherein the tokenization module associates metadata with each digital token, including timestamps, transaction type, and contextual validation scores, and applies homomorphic encryption to secure the digital tokens while allowing computations on encrypted data.

The method further includes publishing, by an event management module, the plurality of digital tokens as events to the decentralized network, wherein the event management module employs an event-driven architecture, integrates with distributed ledger technologies to immutably log the digital tokens on a blockchain, and ensures low-latency distribution of the digital tokens for real-time validation by network participants. The method also involves generating, by a secure multi-party engine, a plurality of sub-tokens from the digital tokens, wherein each sub-token is specific to an application in the decentralized network, contains only the data relevant to the respective application, reflects hierarchical dependencies among data elements in the corresponding transaction version, and is generated using machine learning-based optimization algorithms to minimize computational overhead. Applications within the decentralized network validate their respective sub-tokens by performing a preliminary validation, transmitting validation responses to the secure multi-party engine, and indicating whether the sub-tokens meet the applications'requirements.

The method further includes aggregating, by the secure multi-party engine, the validation responses received from the applications into a consolidated authentication token, wherein the secure multi-party engine employs a threshold-based consensus mechanism requiring validation responses from a predefined minimum number of application nodes to generate the consolidated authentication token. The method also involves re-evaluating, by a final filtering module, the set of valid transaction versions retained by the version filtering module against the consolidated authentication token, wherein the final filtering module discards any transaction versions that do not align with the contents of the consolidated authentication token and retains the transaction version corresponding to the authenticated data. Finally, the method includes preparing, by a transaction processing module, the validated transaction version corresponding to the consolidated authentication token for downstream processing, wherein the transaction processing module formats the validated transaction version for compatibility with subsequent applications in the decentralized network, supports multi-format data outputs including JSON, XML, and custom schemas, and generates a detailed audit trail documenting each step of the method, including missing data detection, prediction, contextualization, token generation, validation, and final preparation, to ensure compliance with regulatory and operational standards.

In some arrangements, a method for managing, validating, and processing transaction data in a decentralized network includes receiving, by a source application interface, an input transaction from a source application, where the source application interface encrypts the input transaction using a dynamically generated encryption key, authenticates the source application through a secure handshake protocol, and verifies the structural integrity of the transaction data prior to forwarding it for processing to ensure secure transmission and prevent tampering. The method further includes detecting, by a missing data detection module, one or more missing data elements in the input transaction, where the missing data detection module uses a pre-trained model trained on historical transaction datasets specific to the transaction type, identifies gaps in the transaction based on domain-specific attributes, and dynamically adapts the detection process using feedback from downstream validated transactions to enable continuous improvement in identifying incomplete or anomalous data patterns.

The method also includes predicting, by a predictive modeling module, the one or more missing data elements identified by the missing data detection module, where the predictive modeling module applies a k-nearest neighbors algorithm enhanced with domain-specific weighting functions to infer the missing data elements based on historical transaction patterns and feature correlations, incorporates temporal features to account for time-sensitive data trends, and integrates supplementary insights from adjacent transactions in the network to further refine the predictions. The predicted missing data elements are integrated into the transaction, and a contextual framework is constructed by a contextualization module, where the contextualization module evaluates logical relationships, sequence dependencies, and semantic relevance of the transaction elements, employs transformer-based semantic analysis to enhance contextual alignment, and queries external data sources, including real-time public APIs, domain-specific knowledge graphs, and distributed sensor networks, to dynamically enrich the contextual framework with additional data insights. The contextualization module generates multiple transaction versions based on the contextual framework, where each transaction version reflects a possible reconstruction of the input transaction that accounts for variations or ambiguities in the data and adheres to predefined structural, logical, and domain-specific consistency requirements.

The method includes filtering, by a version filtering module, the multiple transaction versions to retain a set of valid transaction versions, where the version filtering module applies ensemble modeling techniques to validate and rank the transaction versions, employs dynamically adjusted validation thresholds based on real-time feedback and historical success metrics, prioritizes ensemble models that demonstrate higher accuracy for similar transaction patterns, and incorporates a hybrid validation mechanism that combines rule-based checks with machine learning predictions to ensure robustness. Each valid transaction version is transformed, by a tokenization module, into a corresponding digital token, where each digital token encapsulates the transaction content, contextual metadata, and validation scores. The tokenization module applies homomorphic encryption to secure the tokens, generates cryptographic hashes to ensure traceability and immutability, and assigns a unique digital signature to each token to prevent unauthorized duplication or tampering.

The method further includes publishing, by an event management module, the digital tokens as events to a decentralized network, where the event management module logs the digital tokens immutably on a blockchain infrastructure to provide a tamper-proof record of the transaction lifecycle, ensures low-latency and fault-tolerant distribution of tokens across multiple ledger nodes using redundant publishing mechanisms, and facilitates real-time access to tokens by network participants for further validation. Application-specific sub-tokens are generated, by a secure multi-party engine, from the digital tokens, where each sub-token contains only the data elements relevant to its respective application, is structured to reflect hierarchical dependencies among data attributes, and is generated using machine learning-based optimization algorithms combined with parallel processing techniques to minimize computational overhead and latency. The sub-tokens are validated, by application nodes in the decentralized network, where each application node performs a preliminary validation (soft commit) of the sub-tokens, evaluates the sub-tokens against predefined application-specific validation criteria, generates validation scores based on the compliance of the sub-tokens, and transmits the validation responses to the secure multi-party engine for aggregation.

The method includes aggregating, by the secure multi-party engine, the validation responses received from the application nodes into a consolidated authentication token, where the secure multi-party engine employs a threshold-based consensus mechanism that requires validation responses from a predefined minimum number of application nodes to generate the consolidated authentication token and further verifies the consistency of responses to ensure the integrity of the validation process. The set of valid transaction versions is re-evaluated, by a final filtering module, against the consolidated authentication token, where the final filtering module compares the content, context, and metadata of each transaction version with the authenticated data in the consolidated authentication token, discards any transaction versions that do not align with the authenticated data, and retains the validated transaction version that satisfies all compliance and consistency criteria.

The method also includes preparing, by a transaction processing module, the validated transaction version corresponding to the consolidated authentication token for downstream processing, where the transaction processing module formats the validated transaction version for compatibility with downstream applications, supports multiple output formats including JSON, XML, YAML, and custom schemas, generates a comprehensive audit trail that documents each step of the transaction lifecycle, including missing data detection, prediction, contextualization, token generation, validation, and final preparation, and stores the audit trail in a compliance repository to meet regulatory and operational transparency requirements. The transaction processing module further updates feedback loops between the transaction processing module and upstream modules, including the missing data detection module, predictive modeling module, and version filtering module, where the feedback loops refine the models and validation criteria used by these modules to enable iterative improvements in detection accuracy, prediction precision, contextual alignment, and validation robustness for future transaction processing.

In some arrangements, a system for managing, validating, and processing transaction data in a decentralized network includes a missing data detection module configured to detect one or more missing data elements in an input transaction received from a source application, wherein the missing data detection module utilizes a pre-trained model trained on historical transaction datasets specific to a predetermined domain to identify gaps based on transaction type and associated features, and wherein the pre-trained model is dynamically updated based on feedback from validated transaction versions. The system further includes a predictive modeling module configured to predict the one or more missing data elements identified by the missing data detection module, wherein the predictive modeling module applies a k-nearest neighbors algorithm with a weighted similarity metric to infer the missing data elements based on patterns observed in historical transaction data, and wherein the predictive modeling module incorporates temporal features into the k-nearest neighbors algorithm to account for time-sensitive patterns and trends. The system also includes a contextualization module configured to construct a contextual framework for the input transaction by integrating the predicted missing data elements with the input transaction, wherein the contextualization module evaluates logical relationships, sequence dependencies, and semantic relevance of the data elements, employs transformer-based semantic analysis to enhance contextual alignment, and integrates external data inputs from public APIs or domain-specific knowledge graphs to improve the contextualization process.

The system further includes a version filtering module configured to filter multiple transaction versions generated by the contextualization module to retain a set of valid transaction versions, wherein the version filtering module employs ensemble modeling techniques to combine outputs from multiple pre-trained models, dynamically adjusts filtering thresholds based on historical success rates, and prioritizes models demonstrating higher accuracy for similar transaction types. The system also includes a tokenization module configured to transform each valid transaction version retained by the version filtering module into a plurality of digital tokens, wherein each digital token encapsulates the content and context of its corresponding transaction version, and wherein the tokenization module associates metadata with each digital token, including timestamps, transaction type, and contextual validation scores, and applies homomorphic encryption to secure the digital tokens while allowing computations on encrypted data.

Additionally, the system includes an event management module configured to publish the plurality of digital tokens as events to the decentralized network, wherein the event management module employs an event-driven architecture, integrates with distributed ledger technologies to immutably log the digital tokens on a blockchain, and ensures low-latency distribution of the digital tokens for real-time validation by network participants. The system further includes a secure multi-party engine configured to generate a plurality of sub-tokens from the digital tokens, wherein each sub-token is specific to an application in the decentralized network, contains only the data relevant to the respective application, reflects hierarchical dependencies among data elements in the corresponding transaction version, and is generated using machine learning-based optimization algorithms to minimize computational overhead.

The system also includes a plurality of application nodes configured to validate their respective sub-tokens generated by the secure multi-party engine, wherein each application node performs a preliminary validation of the sub-tokens, transmits validation responses to the secure multi-party engine, and indicates whether the sub-tokens meet the respective application's requirements. The secure multi-party engine is further configured to aggregate the validation responses received from the plurality of application nodes into a consolidated authentication token, wherein the secure multi-party engine employs a threshold-based consensus mechanism requiring validation responses from a predefined minimum number of application nodes to generate the consolidated authentication token. The system further includes a final filtering module configured to re-evaluate the set of valid transaction versions retained by the version filtering module against the consolidated authentication token, wherein the final filtering module discards any transaction versions that do not align with the contents of the consolidated authentication token and retains the transaction version corresponding to the authenticated data. Finally, the system includes a transaction processing module configured to prepare the validated transaction version corresponding to the consolidated authentication token for downstream processing, wherein the transaction processing module formats the validated transaction version for compatibility with subsequent applications in the decentralized network, supports multi-format data outputs including JSON, XML, and custom schemas, and generates a detailed audit trail documenting each step performed by the system, including missing data detection, prediction, contextualization, token generation, validation, and final transaction preparation, to ensure compliance with regulatory and operational standards.

In some arrangements, the pre-trained model utilized by the missing data detection module in the system is further configured to adapt dynamically based on feedback received from the transaction processing module, enabling incremental improvements in the accuracy of detecting missing data elements.

In some arrangements, the predictive modeling module in the system is further configured to prioritize domain-specific features in the k-nearest neighbors algorithm by applying a feature-weighting mechanism that enhances the relevance of predictions for the identified missing data elements.

In some arrangements, the contextualization module in the system is further configured to incorporate real-time data streams from external sources, including domain-specific APIs and distributed knowledge graphs, to dynamically enhance the contextual framework of the input transaction.

In some arrangements, the version filtering module in the system is further configured to use adaptive thresholds based on a feedback loop established with the transaction processing module, wherein the feedback loop adjusts the ensemble model criteria for filtering transaction versions in response to historical validation outcomes.

In some arrangements, the tokenization module in the system is further configured to associate a cryptographic hash with each digital token, wherein the cryptographic hash encapsulates the metadata of the token and serves as an additional layer of traceability and verification within the decentralized network.

In some arrangements, the event management module in the system is further configured to establish redundant event publishing mechanisms using multiple distributed ledger nodes, ensuring robust and fault-tolerant distribution of digital tokens across the decentralized network.

In some arrangements, the secure multi-party engine in the system is further configured to optimize the generation of sub-tokens by utilizing parallel processing techniques and machine learning algorithms that minimize latency in creating application-specific sub-tokens.

In some arrangements, the transaction processing module in the system is further configured to generate a comprehensive audit trail that includes timestamps, source application details, sub-token validation responses, and authentication token data, providing enhanced accountability and traceability for regulatory compliance.

The following description and claims, in conjunction with the drawings—all integral parts of this specification—will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” and “the” used throughout the specification and claims should be interpreted to include their plural counterparts.

### BRIEF DESCRIPTION OF DRAWINGS

FIG. 1 is an exemplary system architecture diagram in accordance with one or more embodiments disclosed herein that illustrates the interaction and functionality of modules and components for managing, validating, and processing transaction data in a decentralized network. The diagram depicts key elements such as the missing data detection module, contextualization module, secure multi-party engine, and blockchain infrastructure, highlighting their interconnected roles in ensuring data accuracy, security, and contextual relevance.

FIG. 2 is an exemplary flow diagram in accordance with one or more embodiments disclosed herein that illustrates the step-by-step process for managing, validating, and processing transaction data within a decentralized network. The diagram depicts the flow of operations, including secure data ingestion, missing data detection, contextualization, tokenization, multi-party validation, and downstream processing with audit trail generation.

FIG. 3 is an exemplary sequence diagram in accordance with one or more embodiments disclosed herein that illustrates the step-by-step interactions between system components for managing, validating, and processing transaction data within a decentralized network. The diagram details the flow of data from secure ingestion through missing data detection, contextualization, tokenization, multi-party validation, and final transaction preparation and storage.

FIG. 4 is an exemplary class diagram in accordance with one or more embodiments disclosed herein that illustrates the system's modular architecture, including its core classes, attributes, methods, and their interconnections for managing, validating, and processing transaction data in a decentralized network. The diagram details components such as the source application interface, predictive modeling module, tokenization module, and blockchain infrastructure, highlighting their roles and relationships in ensuring data accuracy, security, and interoperability.

FIG. 5 is an exemplary process solution diagram in accordance with one or more embodiments disclosed herein that illustrates the sequential steps for detecting, predicting, contextualizing, and validating missing transaction data using a hybrid machine learning and contextual modeling approach. The diagram further demonstrates the integration of tokenization and decentralized validation mechanisms to ensure the accuracy and security of the transaction data throughout its lifecycle.

FIG. 6 is an exemplary solution block diagram in accordance with one or more embodiments disclosed herein that illustrates the interaction between system components for processing, tokenizing, and validating transaction data in a decentralized network. The diagram further demonstrates the flow of data through the custom model, secure multi-party engine, and application-specific sub-token generation, culminating in the creation and authentication of a unified transaction token.

### DETAILED DESCRIPTION

The invention introduces a transformative system and method for managing and validating transaction data within decentralized networks. This system leverages a combination of advanced machine learning algorithms, cryptographic security measures, and decentralized validation mechanisms to maintain the accuracy, security, and contextual relevance of transaction data throughout its lifecycle. Designed to address the complexities of data management in distributed environments, the invention ensures seamless processing of transaction data as it flows across multiple nodes and applications. It offers a highly adaptable framework that can be integrated into industries where data integrity is paramount, such as finance, logistics, and supply chain management, providing a reliable solution for complex and dynamic workflows.

A defining feature of the invention is its missing data detection module, which employs a pre-trained custom model to evaluate transaction data for completeness. This module identifies any gaps in the transaction data structure by analyzing it against historical datasets specific to the domain of application. By doing so, it prevents incomplete or erroneous data from progressing through the system, thereby preserving the consistency and reliability of the transaction data. The use of domain-specific training enhances the precision of this detection process, ensuring the system is attuned to the unique characteristics of various industries.

Once missing data is identified, the invention applies a predictive modeling module to infer the absent elements. This module utilizes the k-Nearest Neighbors algorithm, which excels at analyzing patterns and relationships within data to generate accurate predictions. By prioritizing contextually relevant data through weighted similarity metrics, the algorithm ensures that the predicted data aligns with current trends and practices within the domain. This predictive capability not only restores missing data with a high degree of accuracy but also ensures that it is logically and contextually consistent with the transaction's intended structure and purpose.

To further enhance the relevance of the transaction data, the invention incorporates a contextualization module that integrates the predicted data with the original transaction information. This module evaluates logical dependencies, sequence integrity, and semantic relationships within the data to construct a comprehensive contextual framework. Advanced techniques, including transformer-based models, enable the module to achieve deep contextual understanding, ensuring that the reconstructed transaction reflects the original intent of the source. Multiple versions of the transaction are generated during this phase, each representing a potential configuration of the data that accommodates contextual variations and ambiguities.

The system includes a version filtering module designed to refine the multiple transaction versions generated during contextualization. This module employs ensemble modeling techniques to combine outputs from various pre-trained models, enhancing the accuracy and reliability of the filtering process. It dynamically adjusts filtering thresholds based on historical data, retaining only the most contextually valid and accurate transaction versions. By discarding irrelevant or invalid versions at this stage, the system ensures that only high-quality data progresses to subsequent processing stages, minimizing the risk of errors or inconsistencies.

The invention transforms validated transaction versions into secure digital tokens using a tokenization module. These tokens encapsulate both the content and context of the transaction data, serving as immutable representations of the validated information. Cryptographic techniques, such as homomorphic encryption, are applied during tokenization to safeguard sensitive data while allowing operations to be performed on encrypted tokens. This process ensures that the transaction data remains secure throughout its lifecycle, aligning with the stringent privacy and security requirements of decentralized systems.

To facilitate validation across the decentralized network, the invention employs an event-driven architecture to distribute these tokens as events. This architecture enables low-latency, real-time distribution of tokens to network participants for validation. By integrating with distributed ledger technologies, the event management module creates a tamper-proof log of token events. This ensures transparency and accountability while maintaining the decentralized nature of the system. The use of token-based events reduces dependence on centralized authorities, further enhancing the robustness of the validation process.

The invention introduces a Secure Multi-Party Engine to refine the validation process by creating sub-tokens from the digital tokens. Each sub-token is tailored to the specific requirements of individual applications within the decentralized network. These sub-tokens contain only the data necessary for their respective applications, minimizing unnecessary exposure and optimizing processing efficiency. This granular approach ensures that applications receive precisely the information they need, maintaining a high level of security while improving the efficiency of the validation process.

Applications within the network consume their respective sub-tokens and perform an initial validation process referred to as a soft commit. These applications validate the data contained within the sub-tokens and send their responses back to the Secure Multi-Party Engine. The engine aggregates these responses to create a unified authentication token, representing the collective validation of the transaction data by multiple independent entities. The threshold-based consensus mechanism employed ensures that the validation process is robust and resistant to manipulation, even in scenarios where network participants may not be fully trusted.

A final filtering process evaluates the validated transaction versions against the authentication token to ensure that only the version matching the token is forwarded for further processing. This step discards any transaction versions that do not align with the authenticated token, ensuring that the final data is accurate, contextually coherent, and reflective of the original intent of the transaction. This rigorous validation step guarantees the integrity and reliability of the data as it progresses to downstream applications.

Validated transaction data is then prepared for downstream processing through a transaction processing module. This module formats the data to ensure compatibility with subsequent systems and generates a detailed audit trail documenting every step of the transaction lifecycle. The audit trail provides a transparent and traceable record, ensuring compliance with regulatory requirements and offering stakeholders confidence in the system's operations. This feature is particularly valuable in industries where data accountability is critical.

The system's modular design allows for independent operation of its components while maintaining seamless integration within the overall framework. This architecture supports horizontal scalability, enabling the system to manage increasing transaction volumes without compromising performance or reliability. The event-driven architecture also supports distributed and parallel processing, making the system highly efficient and adaptable to high-throughput environments. This scalability ensures that the invention can meet the evolving demands of decentralized networks.

The invention is highly versatile and can be customized to address the specific needs of various industries. Its pre-trained models can be tailored to the unique requirements of domains such as financial services, logistics, and supply chain management. Additionally, the system's ability to integrate with existing enterprise systems and external data sources enhances its adaptability, enabling seamless implementation in diverse operational environments. This flexibility makes the invention a valuable tool for managing complex transaction workflows across different sectors.

Security and privacy are fundamental aspects of the invention, with cryptographic techniques ensuring the protection of sensitive data throughout its lifecycle. The use of homomorphic encryption allows operations to be performed on encrypted tokens without exposing the underlying data. Furthermore, the hierarchical structure of sub-tokens adds an additional layer of security by limiting data exposure to only what is necessary for each application. These features make the system a trusted solution for managing sensitive transaction data in decentralized networks.

The invention combines machine learning, cryptographic techniques, and decentralized validation mechanisms to address the challenges of managing transaction data in distributed systems. Its innovative approach ensures that data is accurate, contextually aligned, and secure, setting a new benchmark for transaction management. By integrating advanced technologies with a scalable and adaptable framework, the invention provides a robust and reliable solution for complex workflows in decentralized environments. It is a transformative advancement that meets the needs of industries requiring high levels of data integrity and operational reliability, offering a practical and scalable system for the challenges of modern decentralized networks.

The description of various example embodiments herein is intended to achieve the goals previously outlined, referencing the illustrations included in this disclosure. These illustrations depict multiple systems and methods for implementing the disclosed information. It should be recognized that alternative implementations are possible, and modifications to both structure and functionality may be made. The description details various connections between elements, which should be interpreted broadly. Unless explicitly stated otherwise, these connections can be either direct or indirect and may be established through either wired or wireless methods. This document does not aim to restrict the nature of these connections.

In various configurations, terms such as “computers” and “machines” refer to devices that may be general-purpose or specialized for specific tasks, whether physical or virtual, and capable of network connectivity. These devices encompass all necessary hardware, software, and components known to skilled practitioners, including application-specific integrated circuits (ASICs), microprocessors, cores, or other processing units. These components execute, control, or implement various types of software, instructions, data, modules, processes, or routines. The terms used do not restrict the device type and should be broadly interpreted. Software, data, and executable code can reside on various physical, computer-readable storage devices, such as local memory, cloud-based storage, or network-attached storage. These can be stored in both volatile and non-volatile memory and may function autonomously or respond to specific triggers. These elements can be consolidated or distributed across multiple devices and stored in accessible memory systems such as distributed databases, big data infrastructures, blockchains, or distributed ledgers.

Networks and similar references refer to a broad range of communication systems, from local area networks (LANs) and wide area networks (WANs) to the Internet and cloud-based networks, supporting wired and wireless configurations. Specialized networks like digital subscriber line (DSL), frame relay, asynchronous transfer mode (ATM), and virtual private networks (VPN) are included. These networks utilize various hardware and software components, including modems, routers, firewalls, switches, and adapters, to facilitate communication. Networks are also equipped with virtual IP addresses and support multiple protocols like HTTPS, enabling effective packet-based data transmission and communication.

Generative Artificial Intelligence (AI) refers to AI techniques that learn from training data and generate new content, such as text, code, images, and audio. Generative AI systems, often powered by large language models (LLMs) like GPT-3, GPT-4, Meta LLaMA, and others, can be deployed through APIs, search engines, or chatbots. These models, which may be proprietary or open source, leverage deep learning methods and are generally governed by enterprise policies regarding AI and risk. Models such as BERT, T5, AlphaFold, Watson, Megatron, and others play a role in generating or interpreting language and content for various applications.

Generative AI and LLMs are utilized throughout this disclosure for tasks including natural language processing, data analysis, real-time processing, software development, and creative content generation. Specific functions include trend analysis, data classification, sentiment analysis, writing assistance, language translation, and decision-making support. These models enable capabilities like feedback learning, context determination, and comprehensive search operations, improving performance through iterative learning and feedback from human or system interactions. The wide range of applications supported by generative AI makes these systems a powerful tool in generating, analyzing, and managing information across diverse fields. All configurations and uses of these models are within the scope of this disclosure.

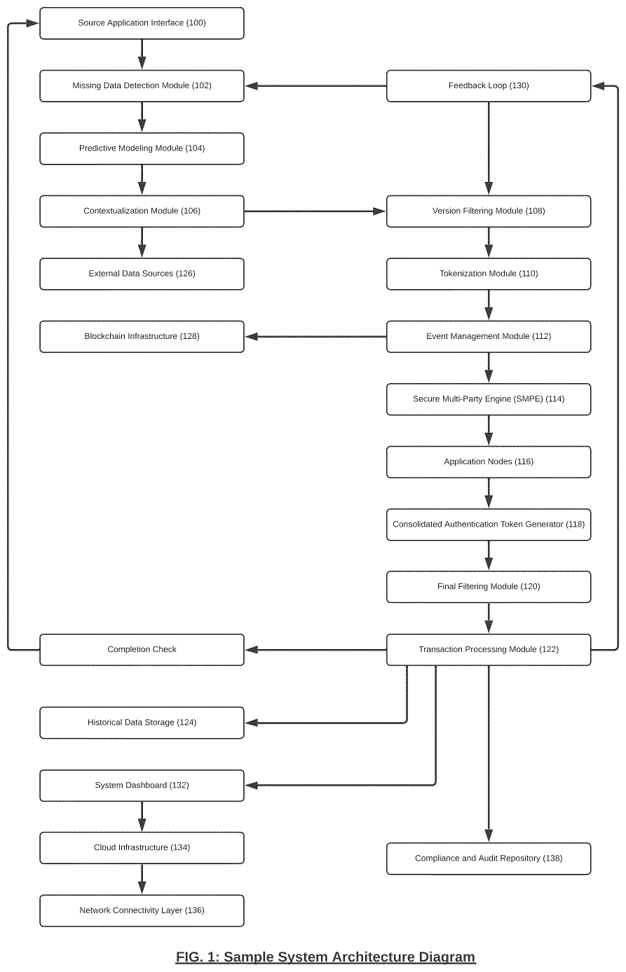

FIG. 1 depicts a detailed system architecture diagram that encapsulates the invention's functionality for managing, validating, and processing transaction data in decentralized networks. At the core of the system is the Source Application Interface (100), which acts as the primary gateway for incoming transaction data. This interface ensures that data from external applications or systems is securely transmitted into the system. Leveraging encryption protocols, the interface guarantees the confidentiality and integrity of the data before forwarding it to subsequent modules. The Source Application Interface (100) is designed to handle a variety of input formats, ensuring compatibility with diverse external applications.

Once the transaction data is received, it is passed to the Missing Data Detection Module (102). This module utilizes a pre-trained model that has been specifically trained on historical transaction datasets relevant to the application domain. By analyzing the transaction data, the module identifies any missing elements or inconsistencies that may compromise the transaction's integrity. The pre-trained model is not static; it is dynamically updated using feedback from validated transactions processed later in the system, allowing it to improve its accuracy over time. This iterative improvement process ensures that the module remains highly effective even as transaction patterns evolve.

After detecting missing data, the Predictive Modeling Module (104) comes into play to address these gaps. This module employs a k-nearest neighbors (KNN) algorithm that calculates similarity metrics for data points within historical datasets. The algorithm is enhanced with temporal features, enabling it to consider time-sensitive patterns and trends when predicting missing data. By leveraging both historical patterns and real-time trends, the module ensures that the predicted data elements are contextually accurate and temporally relevant. The predicted data is then seamlessly integrated into the transaction, creating a preliminary version of a complete transaction dataset.

The integrated transaction is sent to the Contextualization Module (106), which evaluates the logical relationships, sequence dependencies, and semantic relevance of the transaction elements. Using advanced transformer-based semantic analysis models, this module constructs a rich contextual framework for the transaction. To further enhance this contextual framework, the module queries External Data Sources (126), such as domain-specific knowledge graphs or real-time public APIs. These external data inputs enrich the transaction with additional context, ensuring that all generated versions align closely with the original intent and structure of the transaction.

The system generates multiple versions of the transaction, which are passed to the Version Filtering Module (108) for evaluation. This module employs ensemble modeling techniques to validate each version against a set of predefined criteria. By dynamically adjusting filtering thresholds based on historical validation success rates, the module ensures that only the most accurate and contextually valid transaction versions are retained. This dynamic filtering process prioritizes models and criteria that have demonstrated high accuracy for similar transaction types, making the system adaptable to a wide range of scenarios.

Once the valid transaction versions are identified, they are processed by the Tokenization Module (110). This module transforms each validated version into a unique digital token. These tokens encapsulate not only the content of the transaction but also its contextual metadata, such as timestamps, transaction type, and validation scores. The Tokenization Module (110) employs advanced cryptographic techniques, including homomorphic encryption, to ensure that the tokens are secure and traceable. Each token is further secured by generating a cryptographic hash that links the token to its original transaction, providing an additional layer of accountability.

The Event Management Module (112) receives these digital tokens and publishes them as events to the decentralized network. This module leverages an event-driven architecture to ensure low-latency distribution of tokens across the network. By integrating with Blockchain Infrastructure (128), the module immutably logs each token, creating a tamper-proof record of all transactions. To enhance reliability, the Event Management Module (112) employs redundant publishing mechanisms, ensuring fault tolerance and high availability of the tokenized transactions.

The tokens are then processed by the Secure Multi-Party Engine (SMPE) (114), which generates application-specific sub-tokens from the digital tokens. Each sub-token contains only the data relevant to its specific application, reducing unnecessary data exposure and improving processing efficiency. The SMPE (114) uses machine learning-based optimization algorithms and parallel processing techniques to minimize latency in generating sub-tokens. This capability ensures that the system can handle high transaction volumes without compromising performance or security.

The sub-tokens are validated by Application Nodes (116) within the decentralized network. These nodes perform a preliminary validation, referred to as a “soft commit,” and transmit their validation responses back to the SMPE (114). Once the responses are collected, the SMPE aggregates them into a Consolidated Authentication Token (118). This token represents the collective validation outcome of the transaction data and is generated using a threshold-based consensus mechanism that requires input from a predefined number of application nodes to ensure robustness.

The Consolidated Authentication Token (118) is sent to the Final Filtering Module (120), where it is used to re-evaluate the transaction versions retained by the Version Filtering Module (108). Any versions that do not align with the contents of the authentication token are discarded, ensuring that only the most accurate and validated version of the transaction is retained. This step provides a final layer of assurance that the transaction data is reliable and contextually coherent.

The validated transaction version is then prepared for downstream processing by the Transaction Processing Module (122). This module formats the transaction for compatibility with external systems, supporting multiple output formats such as JSON, XML, and custom schemas. The Transaction Processing Module (122) also generates a detailed audit trail that documents every step of the transaction lifecycle, from initial detection to final validation. This audit trail is stored in the Compliance and Audit Repository (138) for regulatory compliance and operational transparency.

The system is supported by several auxiliary components. Historical Data Storage (124) provides the historical datasets used by the Missing Data Detection Module (102) and Predictive Modeling Module (104). A Feedback Loop (130) connects the Transaction Processing Module (122) to upstream modules, allowing the system to iteratively improve its performance. The System Dashboard (132) provides real-time monitoring and management capabilities, giving stakeholders visibility into transaction statuses and system performance. The Cloud Infrastructure (134) ensures the scalability and redundancy of the system, while the Network Connectivity Layer (136) facilitates secure and reliable communication between all components.

Overall, the system architecture depicted in FIG. 1 is a comprehensive, modular, and scalable framework that integrates advanced machine learning, cryptographic techniques, and blockchain technologies. It ensures the accuracy, security, and contextual relevance of transaction data throughout its lifecycle, addressing the challenges of decentralized network environments with unparalleled precision and efficiency.

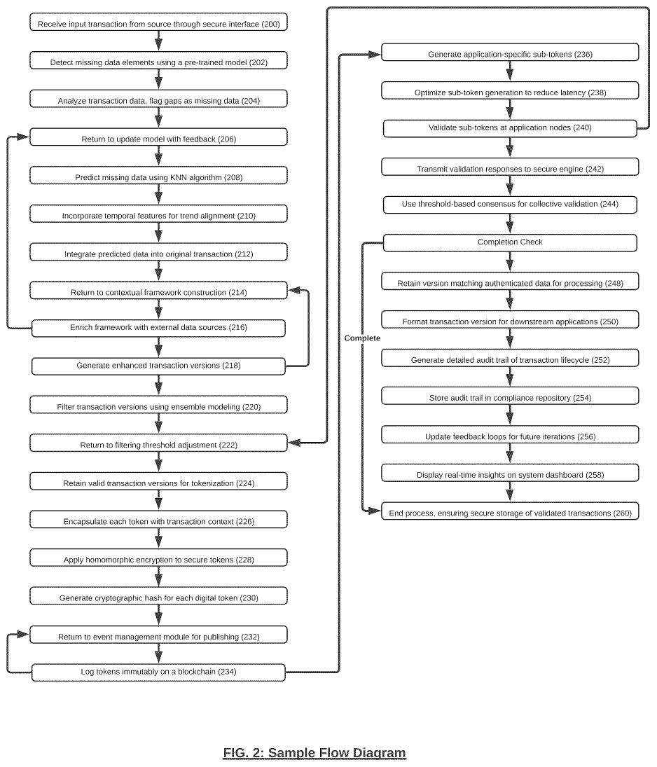

FIG. 2 illustrates a highly detailed and comprehensive flow diagram that captures the operational workflow of the invention, which is designed to manage, validate, and process transaction data within a decentralized network. The process begins with the reception of an input transaction through a secure interface, ensuring that data is encrypted and authenticated to maintain integrity and confidentiality during transmission to the system. This step ensures that external data sources, such as applications or systems, interact with the invention in a secure and seamless manner, preventing unauthorized access or tampering with the data as it is introduced into the system (200). Once received, the transaction data is analyzed by the missing data detection module, which utilizes a pre-trained model that has been trained on historical datasets tailored to specific application domains. The module identifies any gaps or inconsistencies within the input transaction and flags them as missing data elements that require further attention. This dynamic pre-trained model is updated continuously using feedback from later stages of the transaction lifecycle, enabling it to adapt to evolving transaction patterns and improve its accuracy over time (202).

As the missing data detection module identifies gaps, the flagged data is analyzed further to confirm the specific missing elements. These gaps are systematically documented, and the flagged elements are passed along for prediction in the next step of the process. The system ensures that no transaction data with unaddressed missing elements moves forward, preserving the overall integrity of the dataset (204). The flagged missing data elements are handled by the predictive modeling module, which uses a k-nearest neighbors (KNN) algorithm to infer missing values. The algorithm is configured to calculate similarity metrics for each data point in a large historical dataset, ensuring that the most relevant data points are prioritized for prediction. The KNN algorithm integrates temporal features, enabling it to align its predictions with current trends and patterns in the dataset, thereby ensuring that the inferred data elements remain both temporally and contextually accurate (208).

The predicted data elements are then seamlessly integrated into the original transaction to form a preliminary version of a completed transaction. This integration step ensures logical coherence between the predicted data and the original dataset, avoiding redundancies or errors that could compromise downstream processing (212). After integration, the transaction is passed to the contextualization module, where a contextual framework for the transaction is constructed. This module evaluates the logical relationships, sequence dependencies, and semantic relevance of the transaction elements. To enhance the accuracy and depth of the contextual framework, the module queries external data sources, such as APIs and domain-specific knowledge graphs. These sources provide real-time and supplementary information that enriches the contextualization process, ensuring that the transaction is represented with maximum relevance and alignment to its intended purpose (216).

Once enriched, the transaction undergoes a generation step that produces multiple transaction versions. Each version represents a potential configuration of the transaction data, accounting for ambiguities or variations in the contextual inputs. These generated versions are forwarded to the version filtering module for further evaluation (218). In this module, ensemble modeling techniques are employed to validate and rank the transaction versions based on their accuracy and contextual alignment. The system adjusts its filtering thresholds dynamically, relying on historical validation success rates to refine the criteria for selecting valid transaction versions. This adaptive approach ensures that only the most relevant and accurate transaction versions are retained for further processing (222).

The retained transaction versions are then passed to the tokenization module, which encapsulates each validated transaction version into a unique digital token. These tokens are designed to include all critical aspects of the transaction, such as its content, context, and metadata. Metadata fields include timestamps, transaction types, and contextual validation scores, which provide a comprehensive representation of the transaction. To secure the tokens, the module applies homomorphic encryption, ensuring that the tokens remain encrypted throughout their lifecycle while still enabling computations to be performed on the encrypted data. A cryptographic hash is also generated for each digital token, creating a secure link between the token and its originating transaction, which enhances traceability and accountability (230).

The digital tokens are published as events to the decentralized network through an event management module. This module uses an event-driven architecture to facilitate low-latency distribution of tokens to network participants. It also logs each token immutably on a blockchain infrastructure, creating a tamper-proof record of the transaction lifecycle. To enhance reliability, the module employs redundant publishing mechanisms, ensuring that the tokens remain accessible even in the event of network disruptions or failures (234). The secure multi-party engine (SMPE) receives the tokens and generates application-specific sub-tokens tailored to the requirements of individual applications within the network. Each sub-token contains only the data relevant to its associated application, thereby minimizing unnecessary data exposure. The SMPE uses machine learning-based optimization algorithms and parallel processing techniques to generate sub-tokens efficiently, reducing latency and computational overhead (236).

The sub-tokens are validated at decentralized application nodes, where each node performs a preliminary validation process referred to as a “soft commit.” These nodes check whether the sub-tokens meet the specific requirements of their respective applications and transmit validation responses back to the SMPE (240). The secure multi-party engine aggregates these validation responses into a consolidated authentication token. This token represents the collective validation of the transaction data and is generated using a threshold-based consensus mechanism. The consensus mechanism ensures that the validation process is robust and incorporates inputs from a predefined minimum number of application nodes (244).

The consolidated authentication token is used to re-evaluate the transaction versions that were retained by the version filtering module. The final filtering module performs this re-evaluation, discarding any versions that do not align with the authentication token and retaining the version that matches the authenticated data. This ensures that only the most accurate and validated transaction version proceeds to downstream processing (248). The retained version is formatted for compatibility with downstream applications, supporting various output formats such as JSON, XML, and custom schemas. The transaction processing module also generates a detailed audit trail that documents each step of the transaction lifecycle, from initial detection and prediction to validation and preparation (252). The audit trail is stored in a compliance and audit repository for regulatory adherence and operational transparency (254).

Finally, the system updates feedback loops between the transaction processing module and upstream modules to enhance future iterations of the process. Real-time insights into transaction statuses and system operations are displayed on a system dashboard, providing stakeholders with a comprehensive view of the system's performance. The process concludes with the secure storage of validated transactions, ensuring that they are accessible for future use, analysis, or compliance verification (260). This flow diagram encapsulates the entire functionality of the invention, showcasing its modularity, scalability, and innovative approaches to managing and validating transaction data in decentralized networks.

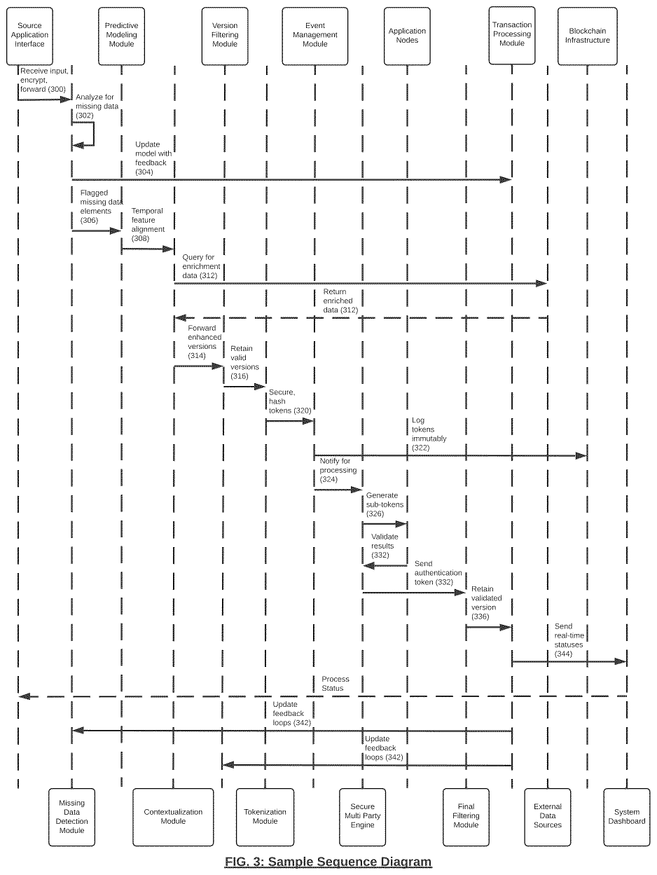

FIG. 3 is an exemplary sequence diagram that comprehensively illustrates the operational interactions and data flow between the various components of the invention for managing, validating, and processing transaction data within a decentralized network. The process begins with the Source Application Interface, which acts as the entry point for input transactions originating from external systems or applications. This interface ensures that the data is securely transmitted using encryption protocols and that the source of the transaction is authenticated to maintain data integrity and prevent unauthorized access. After receiving and verifying the input transaction, the interface forwards the data to the Missing Data Detection Module for further analysis and processing (300).

The Missing Data Detection Module examines the input transaction to identify any missing data elements or structural inconsistencies that could compromise the validity or completeness of the transaction. Utilizing a pre-trained model that has been developed from historical datasets specific to the domain of the transaction, this module is able to detect gaps in the data with high accuracy. As the system processes more transactions, feedback from validated transactions is incorporated back into the pre-trained model, allowing it to dynamically update and improve its accuracy over time. This ensures that the module remains adaptive to evolving transaction patterns and effectively identifies missing elements in a wide variety of contexts (302). Once the missing elements are flagged, the module updates its model with the latest feedback, completing this phase of the workflow (304).

The flagged data elements are then sent to the Predictive Modeling Module, which uses a k-nearest neighbors (KNN) algorithm to infer the missing values. This algorithm performs an analysis of the missing elements in relation to historical transaction data, calculating weighted similarity metrics to identify the most relevant data points for prediction. Additionally, temporal features are incorporated into the algorithm, allowing it to align its predictions with real-time trends and patterns specific to the domain of application. This ensures that the inferred data not only completes the transaction but does so in a way that is contextually and temporally appropriate (306). The predicted data is then integrated with the transaction, forming a preliminary version of a completed transaction dataset that is ready for further contextual processing (308).

The Contextualization Module receives the transaction with the predicted elements and constructs a comprehensive contextual framework. It evaluates the logical relationships, sequence dependencies, and semantic relevance of all data elements within the transaction to ensure that the reconstructed transaction is internally consistent and aligned with its intended purpose. To enrich this contextual framework, the module queries External Data Sources such as domain-specific knowledge graphs, public APIs, and real-time data streams. The responses from these external sources are integrated into the transaction, providing additional contextual insights that enhance the reliability and accuracy of the transaction's data (312). The module generates multiple versions of the enriched transaction, each representing a potential configuration that accounts for variations or ambiguities in the data, and forwards these versions to the Version Filtering Module for validation (314).

The Version Filtering Module plays a critical role in validating the transaction versions generated by the contextualization module. Using ensemble modeling techniques, the module evaluates each version against a set of predefined criteria to ensure that only the most accurate and contextually valid versions are retained. The module dynamically adjusts its filtering thresholds based on historical success rates, allowing it to prioritize models and criteria that have demonstrated high accuracy for similar transactions in the past. This iterative approach ensures that the retained transaction versions are of the highest quality and reliability, suitable for further processing (316). The validated transaction versions are then sent to the Tokenization Module, where they are encapsulated into digital tokens.

The Tokenization Module transforms each validated transaction version into a unique digital token, which encapsulates the transaction's content, context, and metadata. Metadata fields include critical details such as timestamps, transaction types, and contextual validation scores, providing a comprehensive and traceable representation of the transaction. To secure the tokens, the module applies homomorphic encryption, allowing computations to be performed on the encrypted data without exposing its underlying content. Additionally, a cryptographic hash is generated for each token, linking it securely back to its original transaction and enhancing traceability and accountability (320). These tokens are then passed to the Event Management Module for distribution across the decentralized network.

The Event Management Module ensures the publication of the digital tokens as events to the network. It leverages an event-driven architecture to distribute tokens with low latency, making them immediately available to network participants for validation. The tokens are also logged immutably on the Blockchain Infrastructure, creating a tamper-proof record of the transaction lifecycle that can be accessed for auditability and compliance. To ensure fault tolerance, the module employs redundant publishing mechanisms, guaranteeing that the tokens remain accessible even in the event of network disruptions (322). Once published, the module notifies the Secure Multi-Party Engine (SMPE) to initiate the next stage of processing (324).

The Secure Multi-Party Engine generates application-specific sub-tokens from the published digital tokens. Each sub-token is tailored to the specific requirements of individual applications within the network, containing only the data relevant to its intended use. By minimizing unnecessary data exposure, the SMPE ensures that the system remains efficient and secure. To further enhance efficiency, the SMPE employs machine learning-based optimization algorithms and parallel processing techniques, reducing latency and computational overhead during sub-token generation (326). These sub-tokens are then sent to the Application Nodes for validation.

The Application Nodes perform preliminary validations, referred to as “soft commits,” on the sub-tokens to verify their compliance with application-specific criteria. Each node transmits its validation results back to the SMPE, which aggregates the responses into a consolidated authentication token. This token is generated using a threshold-based consensus mechanism, which requires a predefined number of validation responses from the nodes to ensure robustness and agreement on the transaction's validity (332). The consolidated authentication token is then forwarded to the Final Filtering Module.

The Final Filtering Module uses the authentication token to re-evaluate the transaction versions that were retained by the version filtering module. Versions that do not align with the authenticated data are discarded, ensuring that only the validated transaction version is retained for downstream processing (336). The validated transaction version is sent to the Transaction Processing Module, where it is formatted for compatibility with downstream applications. The module supports various data output formats, such as JSON, XML, and custom schemas, to ensure seamless interoperability with different platforms (338).

The Transaction Processing Module also generates a detailed audit trail documenting every step of the transaction lifecycle. This audit trail is stored in the compliance repository for regulatory reporting and operational transparency. Feedback loops are updated between the transaction processing module and upstream modules, such as the missing data detection and version filtering modules, to refine the system's performance and improve future iterations of the process (342). Real-time transaction statuses and insights into system operations are sent to the System Dashboard, allowing stakeholders to monitor and manage the system effectively (344). The process concludes with the secure storage of the validated transaction version, ensuring that it is readily accessible for future use, compliance verification, or analysis (346).

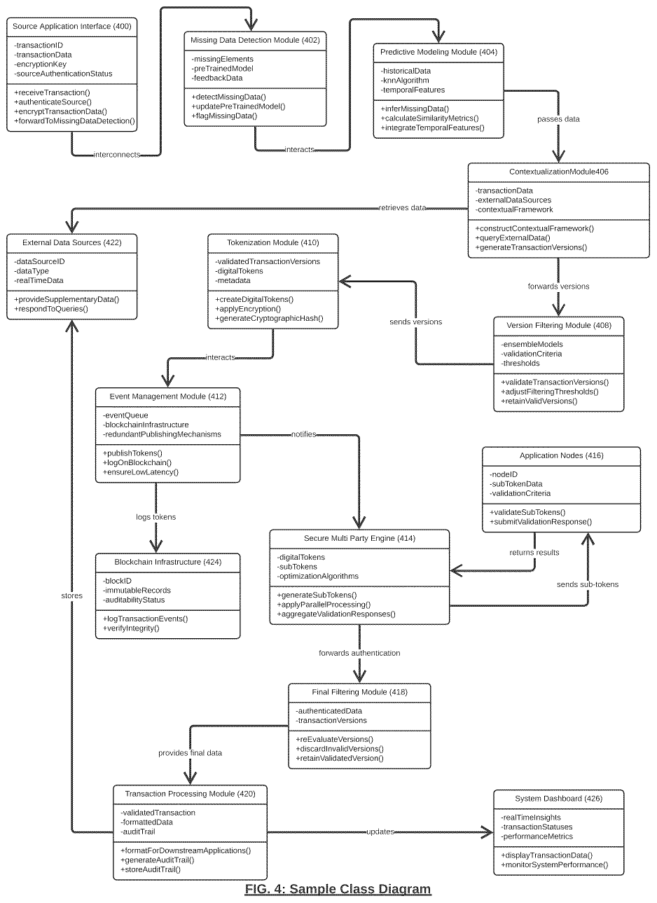

FIG. 4 is a detailed class diagram that thoroughly represents the system architecture, illustrating all key components, their attributes, methods, and the interconnections that facilitate the comprehensive functionality of the invention. At the core of the system is the Source Application Interface (400), which serves as the entry point for incoming transaction data from external applications or systems. This interface ensures secure communication through the use of encryption protocols and source authentication mechanisms. Its attributes include transactionID, which uniquely identifies each incoming transaction; transactionData, which contains the raw data of the transaction; encryptionKey, used for securing the transaction data; and sourceAuthenticationStatus, which confirms whether the source of the transaction has been authenticated. The methods provided by this interface include receiveTransaction( ), which ingests transaction data; authenticateSource( ), which verifies the legitimacy of the transaction's origin; encryptTransactionData( ), which ensures data security before further processing; and forwardToMissingDataDetection( ), which routes the transaction to the Missing Data Detection Module.

The Missing Data Detection Module (402) is responsible for identifying gaps or missing elements in the transaction data. This module relies on a pre-trained model developed from historical datasets to detect inconsistencies with high accuracy. Its attributes include missingElements, which stores information about any detected gaps; preTrainedModel, which is the model used to perform the analysis; and feedbackData, which contains updates and corrections from downstream processes that are used to refine the model over time. The methods detectMissingData( ) analyzes transaction data to identify missing components; updatePreTrainedModel( ) ensures the model evolves dynamically by incorporating feedback from validated transactions; and flagMissingData( ) marks incomplete elements for further prediction and processing.

Once missing elements are flagged, they are sent to the Predictive Modeling Module (404), which predicts the missing data using advanced algorithms. This module's attributes include historicalData, a repository of past transactions used for training and prediction; knnAlgorithm, the k-nearest neighbors algorithm employed for inference; and temporalFeatures, which capture time-sensitive patterns to enhance prediction accuracy. The methods include inferMissingData( ), which generates predictions based on the algorithm; calculateSimilarityMetrics( ), which evaluates the proximity of data points within the historical dataset; and integrateTemporalFeatures( ), which ensures predictions align with real-time trends and the context of the transaction.

The predicted data is forwarded to the Contextualization Module (406), where a contextual framework for the transaction is constructed. This module ensures logical consistency and semantic relevance by analyzing the relationships and dependencies between the data elements. Its attributes include transactionData, which contains the integrated data; externalDataSources, which provide supplementary information for contextual enrichment; and contextualFramework, which represents the constructed context of the transaction. The methods include constructContextualFramework( ), which builds the context; queryExternalData( ), which retrieves additional insights from sources like APIs and domain-specific knowledge graphs; and generateTransactionVersions( ), which creates multiple enhanced versions of the transaction to account for potential variations.

The multiple transaction versions are passed to the Version Filtering Module (408), which evaluates and validates them using ensemble modeling techniques. The attributes of this module include ensembleModels, which represent the collection of models used for validation; validationCriteria, the rules for assessing transaction versions; and thresholds, which dynamically adjust based on historical validation outcomes. The methods include validateTransactionVersions( ), which applies the ensemble models to rank versions; adjustFilteringThresholds( ), which refines validation parameters over time; and retainValidVersions( ), which selects the best versions for further processing.

The validated transaction versions are transformed into digital tokens by the Tokenization Module (410). This module's attributes include validatedTransactionVersions, the input data it processes; digitalTokens, the resulting tokens encapsulating transaction content; and metadata, which includes timestamps, transaction types, and validation scores. The methods include createDigitalTokens( ), which generates the tokens; applyEncryption( ), which secures them using homomorphic encryption; and generateCryptographicHash( ), which ensures traceability by linking tokens to their originating transactions.

The tokens are then managed by the Event Management Module (412), which publishes them as events to the decentralized network. The attributes of this module include eventQueue, a queue of tokens awaiting publication; blockchainInfrastructure, which ensures immutable logging of tokens; and redundantPublishingMechanisms, which guarantee fault-tolerant token distribution. The methods include publishTokens( ), which handles distribution; logOnBlockchain( ), which records tokens immutably for auditability; and ensureLowLatency( ), which optimizes event delivery in real time.

Following this, the Secure Multi-Party Engine (414) processes the digital tokens to generate application-specific sub-tokens. The attributes include digitalTokens, the input for this process; subTokens, the resulting application-specific outputs; and optimizationAlgorithms, which enhance the efficiency of sub-token generation. The methods include generateSubTokens( ), which tailors tokens for individual applications; applyParallelProcessing( ), which minimizes latency; and aggregateValidationResponses( ), which consolidates validation feedback from application nodes.

The Application Nodes (416) are decentralized entities responsible for validating the sub-tokens. Their attributes include nodeID, which uniquely identifies each node; subTokenData, the data they validate; and validationCriteria, the rules they use for verification. The methods include validateSubTokens( ), which performs the validation; and submitValidationResponse( ), which sends results back to the Secure Multi-Party Engine for aggregation.

The Final Filtering Module (418) uses the consolidated authentication token generated by the Secure Multi-Party Engine to re-evaluate the retained transaction versions. Its attributes include authenticatedData, which reflects the consensus validation result; and transactionVersions, the versions being evaluated. The methods include reEvaluateVersions( ), which compares versions against the authenticated data; discardInvalidVersions( ), which eliminates discrepancies; and retainValidatedVersion( ), which finalizes the correct version for downstream use.

The validated transaction is then prepared for external applications by the Transaction Processing Module (420). This module's attributes include validatedTransaction, the final version of the transaction; formattedData, which ensures compatibility with various systems; and auditTrail, a comprehensive record of the transaction's lifecycle. Its methods include formatForDownstreamApplications( ), which prepares the data for further use; generateAuditTrail( ), which creates a detailed log; and storeAuditTrail( ), which archives the log in a compliance repository.

External Data Sources (422) enrich the transaction data during contextualization. Their attributes include dataSourceID, which identifies the source; dataType, which categorizes the data; and realTimeData, which provides live updates. The methods include provideSupplementaryData( ), which supplies additional information; and respondToQueries( ), which retrieves data requested by the Contextualization Module.

The Blockchain Infrastructure (424) ensures the immutability of transaction records. Its attributes include blockID, which uniquely identifies each blockchain entry; immutableRecords, which store the logged tokens; and auditabilityStatus, which guarantees transparency. The methods include logTransactionEvents( ), which records token events; and verifyIntegrity( ), which validates the consistency of stored data.

Finally, the System Dashboard (426) offers real-time monitoring and management of the system. Its attributes include realTimeInsights, which provide immediate visibility into operations; transactionStatuses, which track the progress of transactions; and performanceMetrics, which measure system efficiency. Its methods include displayTransactionData( ), which visualizes transaction information; and monitorSystemPerformance( ), which tracks the overall performance of the system.

The interconnections between these classes ensure seamless data flow and cohesive functionality. For example, the Source Application Interface connects to the Missing Data Detection Module, which in turn interacts with the Predictive Modeling Module for inference. The contextualization and tokenization processes further refine the data, while blockchain and multi-party validation mechanisms ensure security and accuracy. This diagram encapsulates the intricate relationships and modular structure of the system, providing a comprehensive overview of its architecture and functionality.

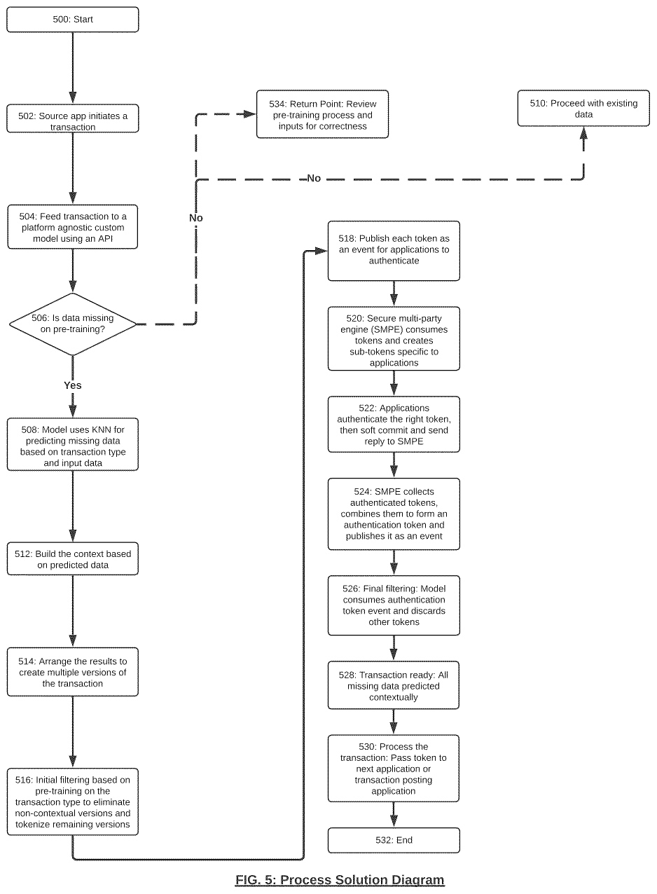

FIG. 5 is an exemplary process solution diagram in accordance with one or more embodiments disclosed herein, illustrating the detailed workflow for processing transactions with missing or incomplete data in a decentralized network. This comprehensive diagram outlines a sequence of steps to detect, predict, contextualize, validate, and prepare transaction data for seamless processing. The process begins with Step 502, where a source application initiates a transaction. The transaction is sent via an API to a platform-agnostic custom model, which has been pre-trained to analyze transaction types. The custom model evaluates the incoming data to determine whether any fields or elements are missing. This initial step is critical for ensuring that incomplete transactions are identified early in the process, preventing errors in downstream applications and preserving the integrity of the transaction.

In Step 504, the custom model proceeds to predict the missing data using a k-Nearest Neighbors (KNN) algorithm. KNN is selected for its robust handling of incomplete datasets, as it can effectively predict missing values by analyzing similarities between data points and related features in the dataset. The algorithm is particularly well-suited for this task because it can infer missing elements without requiring imputation or extensive preprocessing. The pre-trained model uses the transaction type and associated input data to guide the predictions, ensuring that the missing data aligns with the specific requirements and context of the transaction. By leveraging KNN, the system efficiently fills the gaps in the transaction data while maintaining a high degree of accuracy and reliability.

Step 506 involves the integration of the predicted data into the transaction, followed by the construction of a contextual framework by the custom model. The contextualization process evaluates the logical relationships and dependencies among the data elements, ensuring that the predicted data is not only accurate but also contextually coherent. This step ensures that the transaction reflects a realistic and meaningful representation of the intended operation. Step 508 then generates multiple versions of the transaction, each representing a unique arrangement of the existing and predicted data. These versions are created to explore various plausible configurations of the transaction, providing the system with flexibility and resilience in addressing data inconsistencies.

In Step 510, the custom model conducts an initial filtering process based on its pre-trained knowledge of transaction types. The model evaluates the generated transaction versions, identifying and eliminating those that lack contextual validity or relevance. This filtering process reduces the complexity of the data by retaining only the most viable and contextually appropriate transaction versions. These refined versions are then prepared for tokenization in Step 512. Tokenization converts each transaction version into a secure digital token, encapsulating both its content and contextual information. These tokens serve as immutable representations of the transaction versions, ensuring traceability and data integrity throughout the process.

Step 514 involves publishing the tokens to a decentralized network through an event-driven mechanism. Each token represents a version of the transaction and is distributed as an event that applications within the network can access for validation. The event-driven architecture ensures low-latency dissemination of tokens, enabling real-time validation by participating applications. By leveraging distributed ledger technologies, the system creates an immutable record of token events, enhancing transparency and accountability in the decentralized network. This token-based event mechanism is a key feature of the invention, as it decentralizes the validation process and reduces the reliance on centralized authorities.

Step 516 introduces the secure multi-party engine (SMPE), a critical component of the system that refines the validation process. The SMPE consumes the published tokens and breaks them down into application-specific sub-tokens. These sub-tokens are designed to contain only the data relevant to the specific requirements of each application in the transaction path. By tailoring the sub-tokens to the needs of individual applications, the system minimizes unnecessary data exposure and optimizes processing efficiency. The SMPE's ability to segment tokens into granular sub-tokens ensures that each application can focus exclusively on the data that is pertinent to its function.

In Step 518, the applications consume their respective sub-tokens, perform a preliminary validation (referred to as a soft commit), and send their authentication responses back to the SMPE. These responses confirm whether the sub-tokens meet the applications' requirements and are deemed valid. The SMPE collects all the authentication responses and consolidates them into a unified authentication token in Step 520. This authentication token represents the collective validation of all participating applications, providing a robust and decentralized mechanism for ensuring the integrity of the transaction data.

Step 522 describes the final filtering process, where the custom model re-evaluates the transaction versions against the contents of the authentication token. Any versions that do not align with the authentication token are discarded, ensuring that only the most accurate, validated, and contextually coherent version of the transaction is retained. This final filtering step serves as a critical quality control measure, guaranteeing that the transaction data meets the highest standards of accuracy and reliability.

Finally, Step 524 prepares the validated transaction version for downstream processing. At this stage, all missing data has been accurately predicted and contextually integrated, making the transaction complete and ready for further action. The transaction is formatted for compatibility with subsequent applications or transaction posting systems, ensuring seamless integration into the next stage of the workflow. The system also generates a detailed audit trail that documents every step of the process, from initial data detection to final validation. This audit trail provides a transparent and traceable record of the transaction's lifecycle, ensuring compliance with regulatory requirements and instilling confidence among stakeholders.

The workflow depicted in FIG. 5 demonstrates a meticulously designed process for managing and validating transaction data in decentralized networks. It integrates advanced machine learning techniques, such as KNN, with contextual modeling, cryptographic tokenization, and secure multi-party validation to create a robust and scalable solution. By addressing the challenges of incomplete data, ensuring contextual accuracy, and leveraging decentralized validation, the invention establishes a new standard for transaction data management. Each step in the process is carefully orchestrated to ensure that transactions are handled with precision, security, and efficiency, providing a transformative approach to managing complex workflows in distributed systems.

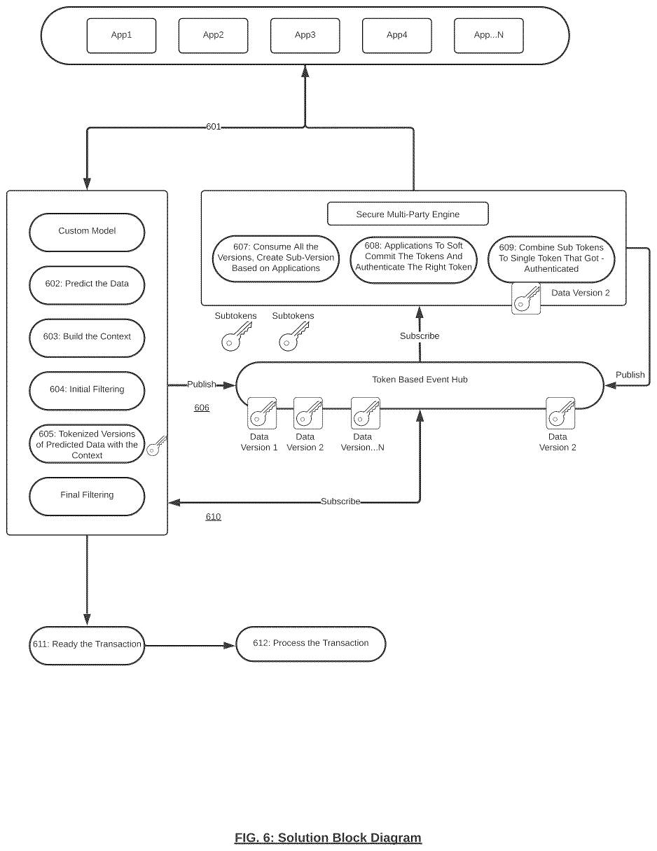

FIG. 6 is an exemplary solution block diagram that demonstrates the intricate interplay between system components designed to process, tokenize, and validate transaction data within a decentralized network. The process begins at Step 601, where the source application initiates a transaction. This transaction is immediately sent to a platform-agnostic custom model via an API. The custom model, pre-trained with specific knowledge of transaction types, evaluates the data for completeness. It determines whether any fields are missing or incomplete, a critical step to ensure data integrity before further processing. The model uses its pre-training to identify gaps in the transaction, flagging incomplete data and preparing it for the next stages of prediction and contextualization.

In Step 602, the system predicts missing data using the k-Nearest Neighbors (KNN) algorithm. This algorithm is particularly effective in handling incomplete datasets because it identifies patterns and similarities within the available data to infer missing values. KNN evaluates transaction data points in relation to historical datasets, selecting the most relevant features to guide its predictions. This approach allows the system to predict missing values while maintaining accuracy and relevance to the transaction's specific context. The system's reliance on KNN is justified by its ability to handle missing data without needing extensive preprocessing. The algorithm considers similarities between data points to make informed predictions, enabling seamless preparation for subsequent processing steps.

Once the missing data is predicted, Step 603 involves integrating this data with the existing elements of the transaction. The custom model constructs a logical and contextual framework that evaluates the dependencies and relationships among the data elements. This ensures that the transaction not only reflects completeness but also adheres to the intended operational logic. This context-building phase allows the system to establish semantic coherence, ensuring that the predicted data aligns with the transaction's original purpose. The result of this process is demonstrated in Step 604, where the model generates multiple transaction versions. Each version represents a unique configuration of the predicted and original data, providing flexibility to handle potential variations and ambiguities in the transaction's structure.

The transaction versions generated in Step 604 are subjected to an initial filtering process in Step 605. The custom model evaluates each version based on pre-trained rules and eliminates those that are not contextually valid or relevant to the transaction type. This step ensures that only the most plausible and contextually accurate versions proceed further, reducing complexity and enhancing the quality of data entering the tokenization phase. The remaining transaction versions are passed to Step 606, where they are transformed into digital tokens. Each token encapsulates the content and contextual information of its respective transaction version, creating an immutable and secure representation. This tokenization process incorporates cryptographic techniques, ensuring the tokens remain secure and resistant to tampering.

In Step 607, the tokens are published to the decentralized network as events. This event-driven architecture ensures that the tokens are distributed in real-time to participating applications, allowing them to authenticate the transaction data independently. The system's integration with distributed ledger technologies provides a tamper-proof log of token events, enhancing transparency and trust among network participants. The tokens serve as unique identifiers for the transaction versions, enabling decentralized validation without reliance on a centralized authority.

The secure multi-party engine (SMPE) is introduced in Step 608, where it begins consuming the published tokens. The SMPE decomposes each token into application-specific sub-tokens, as shown in Step 609. These sub-tokens are tailored to meet the specific requirements of individual applications within the transaction path. Each sub-token contains only the data relevant to its associated application, minimizing unnecessary data exposure and optimizing processing efficiency. This granularity ensures that each application receives exactly the information it needs, reflecting the system's focus on security and precision.

Step 610 illustrates the interaction between applications and the sub-tokens. Applications receive their respective sub-tokens and perform a soft commit by validating their contents. They then send their validation responses back to the SMPE, indicating whether the sub-tokens meet their requirements and are considered valid. In Step 611, the SMPE collects these validation responses and aggregates them into a unified authentication token. This token represents the collective agreement of all participating applications, providing a robust and decentralized mechanism for verifying the transaction data's accuracy and validity. The authentication token is then published back to the network as a new event, signaling the completion of the validation process.

Step 612 marks the final stage, where the custom model consumes the authentication token and uses it to re-evaluate the transaction versions. The model compares each version to the authenticated token, retaining only the version that matches the token's validated content. All other versions are discarded, ensuring that the final transaction is both accurate and contextually valid. This final filtering step guarantees the integrity of the transaction data, preparing it for downstream processing. The validated transaction is then formatted and passed to the next application or transaction posting system, completing the lifecycle with precision and reliability.

The diagram in FIG. 6 reflects a meticulously designed system that integrates advanced modeling techniques, secure multi-party collaboration, and decentralized validation to manage transaction data effectively. Each component contributes to a seamless flow of data, from initial detection and prediction to final validation and preparation. The inclusion of sub-token granularity, application-specific validation, and unified authentication tokens highlights the system's innovative approach to ensuring data integrity and security. By addressing challenges such as incomplete data, decentralized validation, and secure data sharing, the system sets a new standard for transaction management in distributed environments. The level of detail in FIG. 6 underscores the inventors'focus on creating a scalable, secure, and efficient solution for complex workflows, transforming how transaction data is managed and validated in decentralized networks.

Pseudocode exemplars for implementing various aspects of this disclosure are set forth below with explanations for reference.

The pseudocode for implementing the invention includes detailed steps for each aspect of the system, encapsulating all key, core, and unique features. Each module and functionality is represented, ensuring a comprehensive flow from data intake to transaction validation and processing. The pseudocode is designed to facilitate implementation in a modular and scalable way.

The first step involves detecting missing data in an input transaction. The pseudocode initializes the missing data detection module and loads a pre-trained model. The model analyzes the input transaction against historical datasets and identifies gaps based on transaction type and features. If missing data elements are detected, they are flagged for prediction. The pseudocode dynamically updates the model by incorporating feedback from previously validated transactions, allowing it to adapt and improve over time. This process is represented as:
initialize MissingDataDetectionModule
load PreTrainedModel from HistoricalDataset
for each Transaction in InputStream:
   analyze Transaction using PreTrainedModel
   if detect MissingElements:
      flag MissingElements for Prediction
         update PreTrainedModel with Feedback from ValidatedTransactions

The predictive modeling module uses a k-nearest neighbors algorithm to infer the missing elements. The pseudocode iterates through historical datasets, calculates weighted similarity metrics for each neighbor, and selects the most relevant data points. Temporal features are incorporated to align predictions with current trends. The results are integrated into the transaction, creating a comprehensive framework for contextualization.
initialize PredictiveModelingModule
for each MissingElement in MissingElements:
   calculate SimilarityMetrics with HistoricalDataset
   incorporate TemporalFeatures for CurrentTrends
   predict MissingElement based on TopNeighbors
   integrate PredictedElements into Transaction

The contextualization module evaluates the logical relationships between transaction elements. It uses transformer-based models to analyze dependencies and semantic relevance. External data sources, such as APIs and knowledge graphs, are queried to enrich the contextual framework. The pseudocode ensures the module dynamically integrates these inputs to create multiple transaction versions.
initialize ContextualizationModule
for each Transaction in TransactionsWithPredictions:
   evaluate LogicalRelationships and Dependencies
   query ExternalDataSources for Enrichment
      create MultipleTransactionVersions with ContextualEnhancements

The version filtering module processes the multiple transaction versions generated by the contextualization module. It uses ensemble modeling techniques to validate the versions and dynamically adjusts thresholds based on historical validation outcomes. The pseudocode retains only valid transaction versions for further processing.
initialize VersionFilteringModule
for each TransactionVersion in MultipleTransactionVersions:
   validate using EnsembleModeling
   adjust Thresholds based on ValidationHistory
   retain ValidTransactionVersions

The tokenization module creates digital tokens for each validated transaction version. These tokens encapsulate the transaction's content, context, and metadata. Homomorphic encryption ensures security while allowing computations on encrypted data. The pseudocode generates cryptographic hashes for traceability.
initialize TokenizationModule
for each ValidTransactionVersion in ValidTransactionVersions:
   create DigitalToken with Content and Metadata
   apply HomomorphicEncryption for Security
   generate CryptographicHash for Traceability

The event management module publishes tokens as events to the decentralized network. It logs the tokens immutably on a blockchain and uses redundant mechanisms to ensure fault tolerance. The pseudocode ensures low-latency distribution for real-time validation.
initialize EventManagementModule
for each DigitalToken in DigitalTokens:
   publish Token to DecentralizedNetwork
   log Token on Blockchain for Immutability
   ensure RedundantPublishingMechanisms

The secure multi-party engine generates sub-tokens tailored to application-specific needs. Parallel processing minimizes latency, and machine learning algorithms optimize sub-token generation. Applications validate their sub-tokens, and responses are aggregated into a consolidated authentication token.
initialize SecureMultiPartyEngine
for each DigitalToken in DigitalTokens:
   generate SubTokens for Applications
   optimize using ParallelProcessing and MLAlgorithms
   collect ValidationResponses from Applications
   aggregate Responses into ConsolidatedAuthenticationToken

The final filtering module re-evaluates transaction versions against the authentication token. It retains only the version that matches the validated data and discards invalid versions.
initialize FinalFilteringModule
for each ValidTransactionVersion in ValidTransactionVersions:
   if match ConsolidatedAuthenticationToken:
      retain TransactionVersion
   else:
      discard TransactionVersion

The transaction processing module prepares the validated transaction for downstream applications. It formats the data for compatibility, supports multi-format outputs, and generates an audit trail documenting every step.
initialize TransactionProcessingModule
for each ValidatedTransaction in RetainedTransactionVersions:
   format for DownstreamCompatibility
   support MultiFormatOutputs (JSON, XML, Custom)
   generate AuditTrail for Compliance

This pseudocode provides a clear implementation pathway for each module and function within the system. By following these steps, developers can create a scalable and efficient system architecture that adheres to the invention's claims.

A skilled artisan, upon reviewing the disclosure, will appreciate that there are numerous alternatives, modifications, combinations, and customizations that can be made to the systems and methods described herein. More specifically, the systems and methods described herein can be adapted, modified, combined, or customized in numerous ways to suit different applications, environments, and use cases while remaining within the spirit and scope of the disclosure. Below are non-limiting examples of such alternatives, modifications, combinations, and customizations:
a. Alternative Algorithms for Prediction and Analysis: Instead of using the k-nearest neighbors (KNN) algorithm in the predictive modeling module, alternative machine learning or deep learning models, such as decision trees, support vector machines, recurrent neural networks (RNNs), or transformers, could be utilized to improve prediction accuracy and computational efficiency for specific transaction types.
b. Integration with Additional External Data Sources: The contextualization module could be enhanced by integrating with more diverse external data sources, such as IoT devices, real-time sensors, or specialized proprietary databases. This would expand the contextual framework to include richer data insights.
c. Customizable Tokenization Techniques: The tokenization module could support multiple encryption algorithms, such as elliptic-curve cryptography (ECC) or quantum-resistant encryption methods, to address different levels of security requirements or comply with region-specific regulations.
d. Decentralized Architecture Variations: The architecture could be customized to include multiple blockchain systems, each serving distinct aspects of the process, such as separate blockchains for metadata storage, audit logs, and transaction tokens, enhancing scalability and modularity.
e. Dynamic Consensus Mechanisms: The secure multi-party engine could support alternative consensus mechanisms, such as proof-of-stake (PoS), proof-of-authority (PoA), or Byzantine fault-tolerant (BFT) protocols, to suit different network configurations and validation requirements.
f. User-Specific Configurations: The system could allow for user-specific or domain-specific configurations, such as predefined rules in the version filtering module or customized thresholds for validation processes based on industry requirements like finance or supply chain.
g. Real-Time Anomaly Detection: The missing data detection module could incorporate real-time anomaly detection algorithms to flag unusual transaction patterns, improving fraud detection capabilities.
h. Parallel and Distributed Processing Enhancements: The secure multi-party engine and other computationally intensive modules could be enhanced to leverage parallel and distributed processing frameworks like Apache Spark or Kubernetes for handling large-scale data in real-time.
i. Customizable Feedback Loops: the feedback mechanism between downstream modules (e.g., transaction processing module) and upstream modules (e.g., missing data detection module) could be expanded to support user-defined feedback cycles, allowing the system to evolve more effectively for niche applications.
j. Multi-Format Compatibility: The transaction processing module could be customized to support additional output formats, such as YAML, SQL-compatible datasets, or domain-specific schemas for industries like legal, scientific research, or e-commerce.
k. Enhanced Dashboard Customization: The system dashboard could allow for user-defined performance metrics, custom visualizations, and tailored alerts to provide operators with more actionable insights into the system's real-time performance.
l. Cross-Platform and Cross-Protocol Compatibility: The system could be integrated with multiple communication protocols and platforms, such as RESTful APIs, GraphQL, MQTT for IoT, or gRPC, to enhance interoperability with third-party applications and systems.
m. Hybrid Deployment Options: The architecture could be deployed in hybrid environments, combining on-premise systems with cloud-based components, allowing organizations to balance data security and scalability requirements.
n. Dynamic Resource Allocation: The cloud infrastructure supporting the system could include dynamic resource allocation, leveraging AI-driven orchestration tools to optimize system performance and reduce operational costs.
o. Localization and Regional Customization: The system could include localization features, such as language-specific modules, compliance with regional data privacy laws like GDPR or CCPA, and support for different currencies in financial applications.
p. Multi-Tenant Support: The system could be customized to support multi-tenant architectures, allowing multiple users or organizations to securely share the system while maintaining isolated data and processing pipelines.
q. Integration with Emerging Technologies: The system could integrate with emerging technologies, such as augmented reality (AR) or virtual reality (VR), for visualizing transaction data, or with edge computing devices for decentralized processing closer to the data source.
r. Enhanced Validation Mechanisms: Validation processes in the application nodes could include additional layers of cryptographic proofs, such as zero-knowledge proofs (ZKPs), to ensure privacy and integrity in validation without exposing sensitive data.
s. Adaptive Thresholding for Contextual Modules: The contextualization and version filtering modules could employ AI-based adaptive thresholding, dynamically adjusting based on real-time transaction complexity or risk factors.
t. Customizable Sub-Token Formats: Sub-tokens generated by the secure multi-party engine could include user-defined attributes or hierarchical data structures to meet specific application needs, such as supply chain traceability or multi-level compliance tracking.
u. Decoupled Modules for Microservices: The architecture could be redesigned as a microservices-based system, where each module functions independently, allowing for modular deployment, easier updates, and scaling of individual components.
v. Alternative Storage Backends: Instead of relying solely on blockchain infrastructure for storage, the system could support other storage backends, such as distributed hash tables (DHTs), graph databases, or hybrid blockchain-DAG systems, to optimize performance and cost.
w. Enhanced Workflow Automation: Workflow orchestration could be integrated with tools like Apache Airflow or Temporal to provide end-to-end automation of transaction workflows, from data ingestion to validation and storage.
x. Support for Smart Contracts: The system could integrate smart contract functionality to automate processes, such as triggering validation workflows or managing token transfers, based on predefined business logic.
y. Pluggable Machine Learning Models: The machine learning models used in various modules, such as missing data detection and predictive modeling, could be made pluggable, allowing users to choose or integrate models suited to their specific use cases.

These alternatives, modifications, combinations, and customizations enhance the system's versatility and scalability, ensuring it can adapt to a wide range of applications and remain effective across diverse industries and operational environments.

Although the present technology has been described based on what is currently considered the most practical and preferred implementations, it is to be understood that this detail is only for that purpose and this disclosure is not limited to the sample descriptions and implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A method for managing and validating transaction data in a decentralized network, the method comprising:
detecting, by a missing data detection module, one or more missing data elements in an input transaction received from a source application, wherein the missing data detection module utilizes a pre-trained model trained on historical transaction datasets to identify gaps based on transaction type and associated features;
predicting, by a predictive modeling module, the one or more missing data elements identified by the missing data detection module, wherein the predictive modeling module applies a k-nearest neighbors (KNN) algorithm with a weighted similarity metric to infer the missing data elements based on patterns observed in historical transaction data;
integrating, by a contextualization module, the predicted missing data elements with the input transaction to construct a contextual framework for the transaction, wherein the contextualization module evaluates logical relationships, sequence dependencies, and semantic relevance of the data elements to generate multiple transaction versions;
filtering, by a version filtering module, the multiple transaction versions generated by the contextualization module to retain a set of valid transaction versions, wherein the version filtering module employs ensemble modeling techniques using outputs from multiple pre-trained models to enhance accuracy and reliability;
tokenizing, by a tokenization module, each valid transaction version retained by the version filtering module to generate a plurality of digital tokens, wherein each digital token encapsulates the content and context of its corresponding transaction version, and wherein the tokenization module applies homomorphic encryption to ensure security of the digital tokens;
publishing, by an event management module, the plurality of digital tokens as events to a decentralized network, wherein the event management module integrates with distributed ledger technologies to create an immutable record of token events and facilitate low-latency distribution of the digital tokens;
generating, by a secure multi-party engine, a plurality of sub-tokens from the digital tokens, wherein each sub-token is specific to an application in the decentralized network and contains only the data relevant to its respective application;
validating, by a plurality of application nodes in the decentralized network, their respective sub-tokens by performing a preliminary validation and transmitting validation responses to the secure multi-party engine;
aggregating, by the secure multi-party engine, the validation responses received from the plurality of application nodes into a consolidated authentication token, wherein the secure multi-party engine employs a threshold-based consensus mechanism requiring validation responses from a predefined minimum number of application nodes;
re-evaluating, by a final filtering module, the set of valid transaction versions retained by the version filtering module against the consolidated authentication token, wherein the final filtering module discards any transaction versions that do not match the contents of the consolidated authentication token; and
preparing, by a transaction processing module, the validated transaction version corresponding to the consolidated authentication token for downstream processing, wherein the transaction processing module formats the validated transaction version for compatibility with subsequent applications in the decentralized network and generates an audit trail documenting each step performed in the method.

2. The method of claim 1, wherein the pre-trained model utilized by the missing data detection module is dynamically updated based on feedback from validated transaction versions, thereby improving the accuracy of detecting missing data elements over time.

3. The method of claim 2, wherein the predictive modeling module incorporates temporal features into the k-nearest neighbors algorithm, such that the predictions account for time-sensitive patterns and trends in transaction data.

4. The method of claim 3, wherein the contextualization module integrates external data inputs from public APIs or domain-specific knowledge graphs to enrich the contextual framework for the predicted missing data elements, providing additional insights to improve the integration of the data within the transaction.

5. The method of claim 4, wherein the version filtering module adjusts its ensemble modeling techniques dynamically based on the historical success rates of the pre-trained models, prioritizing models that demonstrate higher accuracy for similar transaction types.

6. The method of claim 5, wherein the tokenization module associates metadata with each digital token it generates, including timestamps, transaction type, and contextual validation scores, thereby enhancing traceability and providing additional context for each tokenized transaction version.

7. The method of claim 6, wherein the event management module integrates with distributed ledger technologies, such that the digital tokens are immutably logged on a blockchain to ensure enhanced security, auditability, and transparency for the transactions.

8. The method of claim 7, wherein the secure multi-party engine employs machine learning-based optimization algorithms to minimize computational overhead associated with generating and processing the sub-tokens, thereby improving the scalability of the system.

9. The method of claim 8, wherein the transaction processing module supports multi-format data outputs, including JSON, XML, and custom schemas, to ensure seamless integration of the validated transaction version with a wide variety of downstream applications and enterprise systems.

10. The method of claim 9, wherein the audit trail generated by the transaction processing module includes detailed documentation of each step of the method, including missing data detection, prediction, contextualization, token generation, validation, and final transaction preparation, to ensure compliance with regulatory and operational standards.

11. A method for managing, validating, and processing transaction data in a decentralized network, comprising:
receiving, by a source application interface, an input transaction from a source application, wherein the source application interface encrypts the input transaction using a dynamically generated encryption key, authenticates the source application using a secure handshake protocol, and verifies the structural integrity of the transaction data prior to forwarding it for processing to ensure secure transmission and prevent tampering;
detecting, by a missing data detection module, one or more missing data elements in the input transaction, wherein the missing data detection module utilizes a pre-trained model trained on historical transaction datasets specific to the transaction type, identifies gaps in the transaction based on domain-specific attributes, and adapts the detection process dynamically using feedback from downstream validated transactions, enabling continuous improvement in detecting incomplete or anomalous data patterns;
predicting, by a predictive modeling module, the one or more missing data elements identified by the missing data detection module, wherein the predictive modeling module applies a k-nearest neighbors algorithm enhanced with domain-specific weighting functions to infer the missing data elements based on historical transaction patterns and feature correlations, incorporates temporal features to account for time-sensitive data trends, and integrates supplementary insights from adjacent transactions in the network to refine the predictions further;
constructing, by a contextualization module, a contextual framework for the input transaction by integrating the predicted missing data elements with the input transaction, wherein the contextualization module evaluates logical relationships, sequence dependencies, and semantic relevance of the transaction elements, employs transformer-based semantic analysis to enhance contextual alignment, and queries external data sources, including real-time public APIs, domain-specific knowledge graphs, and distributed sensor networks, to dynamically enhance the contextual framework with additional data insights;
generating, by the contextualization module, multiple transaction versions based on the contextual framework, wherein each transaction version reflects a possible reconstruction of the input transaction that accounts for variations or ambiguities in the data, and wherein the contextualization module ensures that all generated versions adhere to predefined structural, logical, and domain-specific consistency requirements;
filtering, by a version filtering module, the multiple transaction versions to retain a set of valid transaction versions, wherein the version filtering module applies ensemble modeling techniques to validate and rank the transaction versions, employs dynamically adjusted validation thresholds based on real-time feedback and historical success metrics, prioritizes ensemble models that demonstrate higher accuracy for similar transaction patterns, and incorporates a hybrid validation mechanism that combines rule-based checks with machine learning predictions to ensure robustness;
transforming, by a tokenization module, each valid transaction version into a corresponding digital token, wherein each digital token encapsulates the transaction content, contextual metadata, and validation scores, and wherein the tokenization module applies homomorphic encryption to secure the tokens, generates cryptographic hashes to ensure traceability and immutability, and assigns a unique digital signature to each token to prevent unauthorized duplication or tampering;
publishing, by an event management module, the digital tokens as events to a decentralized network, wherein the event management module logs the digital tokens immutably on a blockchain infrastructure to provide a tamper-proof record of the transaction lifecycle, ensures low-latency and fault-tolerant distribution of tokens across multiple ledger nodes using redundant publishing mechanisms, and facilitates real-time access to tokens by network participants for further validation;
generating, by a secure multi-party engine, application-specific sub-tokens from the digital tokens, wherein each sub-token contains only the data elements relevant to its respective application, is structured to reflect hierarchical dependencies among data attributes, and is generated using machine learning-based optimization algorithms combined with parallel processing techniques to minimize computational overhead and latency;
validating, by application nodes in the decentralized network, the application-specific sub-tokens, wherein each application node performs a preliminary validation (soft commit) of the sub-tokens, evaluates the sub-tokens against predefined application-specific validation criteria, generates validation scores based on the compliance of the sub-tokens, and transmits the validation responses to the secure multi-party engine for aggregation;
aggregating, by the secure multi-party engine, the validation responses received from the application nodes into a consolidated authentication token, wherein the secure multi-party engine employs a threshold-based consensus mechanism that requires validation responses from a predefined minimum number of application nodes to generate the consolidated authentication token, and further verifies the consistency of responses to ensure the integrity of the validation process;
re-evaluating, by a final filtering module, the set of valid transaction versions against the consolidated authentication token, wherein the final filtering module compares the content, context, and metadata of each transaction version with the authenticated data in the consolidated authentication token, discards any transaction versions that do not align with the authenticated data, and retains the validated transaction version that satisfies all compliance and consistency criteria;
preparing, by a transaction processing module, the validated transaction version corresponding to the consolidated authentication token for downstream processing, wherein the transaction processing module formats the validated transaction version for compatibility with downstream applications, supports multiple output formats including JSON, XML, YAML, and custom schemas, generates a comprehensive audit trail that documents each step of the transaction lifecycle, including missing data detection, prediction, contextualization, token generation, validation, and final preparation, and stores the audit trail in a compliance repository to meet regulatory and operational transparency requirements; and
updating, by the transaction processing module, feedback loops between the transaction processing module and upstream modules including the missing data detection module, predictive modeling module, and version filtering module, wherein the feedback loops refine the models and validation criteria used by these modules, enabling iterative improvements in detection accuracy, prediction precision, contextual alignment, and validation robustness for future transaction processing.

12. A system for managing, validating, and processing transaction data in a decentralized network, the system comprising:
a missing data detection module configured to detect one or more missing data elements in an input transaction received from a source application, wherein the missing data detection module utilizes a pre-trained model trained on historical transaction datasets specific to a predetermined domain to identify gaps based on transaction type and associated features, and wherein the pre-trained model is dynamically updated based on feedback from validated transaction versions;
a predictive modeling module configured to predict the one or more missing data elements identified by the missing data detection module, wherein the predictive modeling module applies a k-nearest neighbors (KNN) algorithm with a weighted similarity metric to infer the missing data elements based on patterns observed in historical transaction data, and wherein the predictive modeling module incorporates temporal features into the KNN algorithm to account for time-sensitive patterns and trends;
a contextualization module configured to construct a contextual framework for the input transaction by integrating the predicted missing data elements with the input transaction, wherein the contextualization module evaluates logical relationships, sequence dependencies, and semantic relevance of the data elements, employs transformer-based semantic analysis to enhance contextual alignment, and integrates external data inputs from public APIs or domain-specific knowledge graphs to improve the contextualization process;
a version filtering module configured to filter multiple transaction versions generated by the contextualization module to retain a set of valid transaction versions, wherein the version filtering module employs ensemble modeling techniques to combine outputs from multiple pre-trained models, dynamically adjusts filtering thresholds based on historical success rates, and prioritizes models demonstrating higher accuracy for similar transaction types;
a tokenization module configured to transform each valid transaction version retained by the version filtering module into a plurality of digital tokens, wherein each digital token encapsulates the content and context of its corresponding transaction version, and wherein the tokenization module associates metadata with each digital token, including timestamps, transaction type, and contextual validation scores, and applies homomorphic encryption to secure the digital tokens while allowing computations on encrypted data;
an event management module configured to publish the plurality of digital tokens as events to the decentralized network, wherein the event management module employs an event-driven architecture, integrates with distributed ledger technologies to immutably log the digital tokens on a blockchain, and ensures low-latency distribution of the digital tokens for real-time validation by network participants;
a secure multi-party engine configured to generate a plurality of sub-tokens from the digital tokens, wherein each sub-token is specific to an application in the decentralized network, contains only the data relevant to the respective application, reflects hierarchical dependencies among data elements in the corresponding transaction version, and is generated using machine learning-based optimization algorithms to minimize computational overhead;
a plurality of application nodes configured to validate their respective sub-tokens generated by the secure multi-party engine, wherein each application node performs a preliminary validation of the sub-tokens, transmits validation responses to the secure multi-party engine, and indicates whether the sub-tokens meet the respective application's requirements;
the secure multi-party engine further configured to aggregate the validation responses received from the plurality of application nodes into a consolidated authentication token, wherein the secure multi-party engine employs a threshold-based consensus mechanism requiring validation responses from a predefined minimum number of application nodes to generate the consolidated authentication token;
a final filtering module configured to re-evaluate the set of valid transaction versions retained by the version filtering module against the consolidated authentication token, wherein the final filtering module discards any transaction versions that do not align with the contents of the consolidated authentication token and retains the transaction version corresponding to the authenticated data; and
a transaction processing module configured to prepare the validated transaction version corresponding to the consolidated authentication token for downstream processing, wherein the transaction processing module formats the validated transaction version for compatibility with subsequent applications in the decentralized network, supports multi-format data outputs including JSON, XML, and custom schemas, and generates a detailed audit trail documenting each step performed by the system, including missing data detection, prediction, contextualization, token generation, validation, and final transaction preparation, to ensure compliance with regulatory and operational standards.

13. The system of claim 12, wherein the pre-trained model utilized by the missing data detection module is further configured to adapt dynamically based on feedback received from the transaction processing module, enabling incremental improvements in the accuracy of detecting missing data elements.

14. The system of claim 13, wherein the predictive modeling module is further configured to prioritize domain-specific features in the k-nearest neighbors algorithm by applying a feature-weighting mechanism that enhances the relevance of predictions for the identified missing data elements.

15. The system of claim 14, wherein the contextualization module is further configured to incorporate real-time data streams from external sources, including domain-specific APIs and distributed knowledge graphs, to dynamically enhance the contextual framework of the input transaction.

16. The system of claim 15, wherein the version filtering module is further configured to use adaptive thresholds based on a feedback loop established with the transaction processing module, wherein the feedback loop adjusts the ensemble model criteria for filtering transaction versions in response to historical validation outcomes.

17. The system of claim 16, wherein the tokenization module is further configured to associate a cryptographic hash with each digital token, wherein the cryptographic hash encapsulates the metadata of the token and serves as an additional layer of traceability and verification within the decentralized network.

18. The system of claim 17, wherein the event management module is further configured to establish redundant event publishing mechanisms using multiple distributed ledger nodes, ensuring robust and fault-tolerant distribution of digital tokens across the decentralized network.

19. The system of claim 18, wherein the secure multi-party engine is further configured to optimize the generation of sub-tokens by utilizing parallel processing techniques and machine learning algorithms that minimize latency in creating application-specific sub-tokens.

20. The system of claim 19, wherein the transaction processing module is further configured to generate a comprehensive audit trail that includes timestamps, source application details, sub-token validation responses, and authentication token data, providing enhanced accountability and traceability for regulatory compliance.
